(19) United States
(12) Patent Application Publication
(10) Pub. No.: US 2024/0373954 A1
(43) Pub. Date: Nov. 14, 2024

(54) A SEALING ARRANGEMENT FOR A GARMENT

(71) Applicants: SI TECH AB, BRASTAD (SE); WATERPROOF DIVING INTERNATIONAL AB, PARTILLE (SE)

(72) Inventors: Jonas AXELSSON, BRASTAD (SE); Göran EHLMÉ, HENÅN (SE)

(73) Assignees: SI TECH AB, BRASTAD (SE); WATERPROOF DIVING INTERNATIONAL AB, PARTILLE (SE)

(21) Appl. No.: 18/691,957

(22) PCT Filed: Sep. 20, 2022
(86) PCT No.: PCT/EP2022/076004

§ 371 Date: Mar. 14, 2024

(30) Foreign Application Priority Data
Sep. 21, 2021 (SE) 2151147-2

(51) Int. Cl. A41D 13/00; A41D 27/10

(52) U.S. Cl. CPC A41D 13/0005; A41D 27/10; A41D 2300/30

(57) ABSTRACT

A sealing arrangement that has an annular base portion and a pair of first and second flexible sleeve portions extending from the annular base portion and configured to form corresponding first and second sealing connector portions, respectively. Each of the flexible sleeve portions has a proximal portion and a distal portion in relation to the annular base portion, said proximal portions extending radially spaced apart from the annular base portion, wherein the second flexible sleeve portion is configured to be turnable about an annular imaginary line and between an open position and a sealing-connecting position relative to the first flexible sleeve portion, in which at least a portion of the second flexible sleeve portion is superposed the first flexible sleeve portion. The first and second flexible sleeve portions are further configured to form a friction fit over a portion of an annular flexible wearable layer in said sealing-connecting position.

### TECHNICAL FIELD

The present disclosure relates to a sealing arrangement for a garment. The disclosure also relates to a sealing connector assembly comprising such sealing arrangement and an annular flexible wearable layer. The disclosure also relates to a garment comprising such sealing arrangement. In particular, the sealing arrangement is configured to inter-connect with a tubular portion for providing a fluid-tight sealing, including e.g. a liquid-tight sealing, such as a water-tight sealing, or a gas-tight sealing, such as an air-tight sealing.

The present disclosure can be applied to garments such as garments for weather protection, fluid-protective garments, such as waterproof garments, water-resistant garments, diving suits, dry suits, protection suits, wet suits, work wear, and other clothing for sport and leisure. Although the disclosure will be described with respect to a diving suit, the disclosure is not restricted to this particular garment, but may also be used in other fluid-protective garments and light-weight garments such as e.g. waterproof jackets and/or waterproof pants, and garments which may be subject to high external forces such as e.g. off-shore applications.

### BACKGROUND

In the field of garments, such as protective garments, e.g. dry suits and diving suits, there are a number of solutions relating to sealing arrangements for sealing a wearer of the garment, or certain parts of the wearer, from e.g. a fluid such as water or contaminated air/gas. By way of example, in a diving suit, the garment around the neck may need to be sealingly connected to a diving cap or diving helmet in order to provide suitable sealing for the wearer from the surroundings when diving. Similarly, the feet and hands of the wearer, i.e. the garment around the wrists and cuffs of the diving suit, may need to be sealingly connected to diving gloves and diving boots, respectively. In other situations, an outdoor worker may want to stay dry during inclement weather, and may thus often use a wearable water-resistant garment to prevent rain from entering through the garments and in-between layers of garments. Similar to the example for diving suits, not only the rain boots may need to provide a water-tight connection with the rain trousers, but also rain gloves may need to be sealingly connected to the rain jacket. Thus, for many applications, there is a need to sealingly connect a wearable layer or a portion of a garment, e.g. the glove of a work wear garment, the neck of a diving suit or portions around the waist line, to another wearable layer of the garment, e.g. a diving cap/helmet, a rain jacket or a pair of rain trousers, respectively.

WO 2017/060467 discloses one type of garment for a wearer, in which the garment such as a diving suit comprises a number of sealing arrangement. By way of example, a cuff portion of the diving suit has a sealing arrangement with a sealing device and a reinforcement clip. The sealing device is provided with an annular sealing body adapted to be locked into a recess to sealingly connect a wearable layer between an annular base and the annular sealing body. Further, the reinforcement clip is arranged to be locked to the sealing device.

While there are a number of different garments to be used in a wet environment in order to keep a wearer dry by being waterproof and/or water repellent, there is still an increasing demand for sealingly connect parts of such garments in a secure, yet user-friendly and intuitive manner.

### SUMMARY OF THE DISCLOSURE

An object of the disclosure is to provide a reliable annular sealing connector arrangement for a garment, which is intended to be inter-connected with an opposite annular flexible wearable layer.

According to a first aspect of the disclosure, this object is at least partly achieved by the features of claim 1. According to a second aspect of the disclosure, the object is at least partly achieved by the features of claim 2. According to a third aspect of the disclosure, the object is at least partly achieved by the features of claim 20. According to a fourth aspect of the disclosure, the object is at least partly achieved by the features of claim 21. According to a fourth aspect of the disclosure, the object is at least partly achieved by the features of claim 23.

According to the first aspect thereof, there is provided a sealing arrangement for garments to sealingly connect with an annular flexible wearable layer. The sealing arrangement comprises an annular base portion and a pair of first and second flexible sleeve portions extending from the annular base portion and configured to form corresponding first and second sealing connector portions, respectively. Each one of the first and second flexible sleeve portions comprises a proximal portion and a distal portion in relation to the annular base portion. The proximal portions extend radially spaced apart from the annular base portion. The second flexible sleeve portion is configured to be turnable about an annular imaginary line and between an open position and a sealing-connecting position relative to the first flexible sleeve portion, in which at least a portion of the second flexible sleeve portion is superposed the first flexible sleeve portion. Moreover, the first and second flexible sleeve portions are configured to form a friction fit over a portion of the annular flexible wearable layer in the sealing-connecting position.

That is, the first and second flexible sleeve portions are configured to form the friction fit over a portion of the annular flexible wearable layer when the second flexible sleeve portion is in the sealing-connecting position.

The friction fit may generally be provided by a circumferential difference between portions of the second flexible sleeve portion and the first flexible sleeve portion. In addition, or alternatively, the friction fit may generally be provided by a circumferential difference between a portion of the second flexible sleeve portion and the annular flexible wearable layer, as defined when the annular flexible wearable layer is arranged about the first flexible sleeve portion. Hence, the friction fit can be provided in several different manners, as further described herein. In one example, the friction fit is provided by (“when”) the second flexible sleeve portion being arranged and positioned in the sealing-connecting position as an outer circumferential sleeve, and where its distal portion has an inner circumference that is smaller than an outer circumference of the distal portion of an inner circumferential sleeve (e.g. the first flexible sleeve portion). In addition, or alternatively, the friction fit is provided by (“when”) the second flexible sleeve portion is in the sealing-connecting position as an outer circumferential sleeve, and where its distal portion comprises an inner circumference that is smaller than an outer circumference of the annular flexible wearable layer, as measured when the annular flexible wearable layer is arranged annularly about the distal portion of the inner circumferential sleeve (e.g. the first flexible sleeve portion). Any one of these configurations of the sleeve portions may provide for a friction engagement between mating sealing surfaces of the second flexible sleeve portion and the annular flexible wearable layer as well as friction engagement between mating sealing surfaces of the first flexible sleeve portion and the annular flexible wearable layer.

In other words, the friction fit is obtained by a circumferential difference between the inner circumference of the second flexible sleeve portion and the outer circumference of the distal portion of the first flexible sleeve portion, and/or a circumferential difference between the inner circumference of the second flexible sleeve portion and the outer circumference of the annular flexible wearable layer (as determined in a state where the annular flexible wearable layer is arranged about the first flexible sleeve portion).

Moreover, a friction fit arrangement is different to a connection provided by a hook-and-loop fastener system (such as Velcro fasteners), which is not held together by friction. Hence, it should be readily appreciated that the term friction fit refers to a sealing-connecting arrangement wherein at least portions of the first and second flexible sleeve portions hold the annular flexible wearable layer in place by means of friction. The friction fit is obtained due to the flexible material characteristics of the components making up the first and second flexible sleeve portions and the annular flexible wearable layer in combination with the dimensional difference, as mentioned herein. The friction fit provides tension between the first and second flexible sleeve portions corresponding to a pressure fit. As such, the friction fit is obtained due to the flexible material characteristics of the sleeve portions and the annular flexible wearable layer in combination with the dimensional difference between the second flexible sleeve portion (the radially outer flexible sleeve portion) and the annular wearable layer being arranged on the first flexible sleeve portion (the radially inner flexible sleeve portion). By this configuration, tension is created circumferentially around the annular flexible wearable layer and the distal portion of the first flexible sleeve portion (the inner circumferential flexible sleeve portion), that may genereally correspond to the function of a pressure fit therebetween.

The friction fit is particularly suitable for providing a fluid-tight sealing between sealing surfaces of the first and second flexible sleeve portions and at least a portion of the inserted annular flexible wearable layer due to the flexible material characteristics of the components making up the first and second sleeve portions and the annular wearable layer.

In addition, by the configuration of the friction fit, parts of the first and second flexible sleeve portions are configured to sealingly connect the inserted annular flexible wearable layer of the other garment portion to the sealing arrangement, thus forming a fluid-tight and connected configuration. The sealing-connecting configuration is formed between mating sealing surfaces of the sealing arrangement and the inserted annular wearable layer. More specifically, in the sealing-connecting configuration, the second flexible sleeve portion circumferentially encloses the first flexible sleeve portion and holds the annular flexible wearable layer therebetween by the friction fit connection, whereby the fluid-tight seal configuration is provided over the circumferential connection between the first and second flexible sleeve portions and the annular wearable layer.

According to the second aspect thereof, there is provided a sealing arrangement for garments to sealingly connect with an annular flexible wearable layer, having an annular base portion and a pair of first and second flexible sleeve portions extending from the annular base portion and configured to form corresponding first and second sealing connector portions, respectively. Each one of the first and second flexible sleeve portions comprises a proximal portion and a distal portion in relation to the annular base portion. The proximal portions extend radially spaced apart from the annular base portion. Moreover, one of the first and second flexible sleeve portions is an outer circumferential sleeve and the other one of the first and second flexible sleeve portions is an inner circumferential sleeve, and wherein at least an inner circumference of the distal portion of the outer circumferential sleeve is smaller than an outer circumference of the distal portion of the inner circumferential sleeve.

Further, the second flexible sleeve portion is configured to be turnable about an annular imaginary line between an open position and a sealing-connecting position relative to the first flexible sleeve portion, in which at least a portion of the second flexible sleeve portion is superposed the first flexible sleeve portion.

Hereby, the first and second flexible sleeve portions are configured to sealingly connect the inserted annular wearable layer of another garment portion to the sealing arrangement in a fluid-tight and connected configuration. That is, the sealing-connecting configuration is formed between mating sealing surfaces of the sealing arrangement and the inserted annular wearable layer.

The proposed sealing arrangement provides a device with a reduced number of loose parts and is thus particularly beneficial for ordinary use with garments in an outdoor environment.

By having an annular base portion and a pair of first and second flexible sleeve portions extending from the annular base portion, there is provided a single piece with essentially no loose parts. In addition, by this arrangement of an annular base portion and a pair of first and second flexible sleeve portions extending from the annular base portion there is provided two tubular portions extending from the annular base portion so that the sealing arrangement may not collapse when the second flexible sleeve portion is turned radially atop the first flexible sleeve portion when forming the friction fit with the annular wearable layer, and thus forming a fluid-tight configuration therebetween in the sealing-connecting position.

While the annular base portion and the pair of first and second flexible sleeve portions may be provided in the form of a one-piece moulded arrangement or provided as separate parts being securely attached to each other, the configuration of having them to extend from each other ensures that the sealing arrangement may not easily collapse during use thereof in a garment.

Further, the proposed sealing arrangement provides for a circumferentially tensioned configuration due to the arrangement and configuration of the circumferentially extending annular base portion and the pair of first and second flexible sleeve portions.

Moreover, in the sealing-connecting position, the proximal portions are configured to collectively define an intermediate annular space for accommodating a portion of the annular flexible wearable layer. In other words, the proximal portions are configured to collectively define an intermediate annular space for accommodating a portion of the annular flexible wearable layer when the annular flexible wearable flexible layer is arranged in-between the first and second flexible sleeve portions.

In the sealing-connecting position, the second sleeve sealing connector portion may be arranged such that at least the distal portion of the second sleeve sealing connector portion exerts a substantial pressure against the distal portion of the first sleeve sealing connector portion for causing a portion of the annular wearable layer to expand within the defined intermediate annular space so as to collectively form the sealing-connecting configuration with the first and second flexible sleeve portions forming the sealing connector portions or the arrangement.

By means of having flexible sleeve portion components that are arranged and configured to define the intermediate annular space, the annular flexible wearable layer is allowed to expand within the space and frictionally engage with the surfaces of the proximal portions defining the space. To this end, the combination of the space and the friction fit configuration of the sleeve portions further improves the seal and connector arrangement.

The intermediate annular space can be provided in several different ways as described in the following. By way of example, the intermediate annular space may be defined by the arrangement of the proximal portions of the first and second flexible sleeve portions, respectively. In addition, or alternatively, the intermediate annular space may be defined by the arrangement of the surfaces of proximal portions of the first and second flexible sleeve portions, respectively, in combination with a side surface of the annular base portion. Alternatively, the intermediate annular space may be defined by the arrangement of the distal portions of the first and second flexible sleeve portions, respectively.

In one embodiment, the intermediate annular space may at least partly be defined by an annular groove in any one of the proximal portions of the first and second flexible sleeve portions. By way of example, the intermediate annular space may be defined by an annular groove in the first flexible sleeve portions. In another example, the intermediate annular space may be defined by an annular groove in the second flexible sleeve portions. The other one of the proximal portions of the first and second flexible sleeve portions may comprise an essentially linear surface. The linear surface may be defined by an essentially flat surface.

The annular groove may be a first annular groove and the other one of the proximal portions of the first and second flexible sleeve portions may comprise a corresponding second annular groove. The corresponding second annular groove may define a larger space in an axial direction and in a radial direction than the first annular groove.

In addition, or alternatively, the intermediate annular space can be provided in the form of a curvature and/or in a stepwise manner. Typically, the intermediate annular space and an outer part of the annular flexible wearable layer are complementary shapes. The complementary shapes may contribute to an improved positioning of the annular flexible wearable layer in-between the sleeve portions when inter-connecting tubular portions with each other. However, other types of shapes are also conceivable for the annular space and the outer part of the annular flexible wearable layer.

Typically, at least sealing portions of parts of the first and second flexible sleeve portions are configured to collectively define the intermediate annular space for accommodating a portion of the annular flexible wearable layer, when arranged in the sealing-connecting position.

By way of example, in the sealing-connecting position, the proximal portions of the first and second flexible sleeve portions are configured to collectively define the intermediate annular space for accommodating a portion of the annular flexible wearable layer. In addition, or alternatively, in the sealing-connecting position, the distal portions of the first and second flexible sleeve portions are configured to collectively define the intermediate annular space for accommodating a portion of the inserted annular flexible wearable layer.

The annular space may resemble a circle, a truncated ellipse, a rectangle, a truncated triangle or any other geometrical shape suitable for accommodating another portion of an annular flexible wearable layer. In the context of the shape of the annular space, the shape, e.g. the rectangle, refers to the shape of the annular space in a cross-sectional view extending in a radial direction and the height (axial) direction of the sealing arrangement.

The proximal portion of the second flexible sleeve portion may comprise a radial projection arranged to cause an advancement of the insertable annular flexible wearable layer towards the annular base portion when the second flexible sleeve portion is turned from the open position into the sealing-connecting position.

The distal portion of the second flexible sleeve portion may comprise a radial rib end portion configured to extend axially beyond the distal portion of the first flexible sleeve portion when the second flexible sleeve portion is turned into the sealing-connecting position.

The second flexible sleeve portion may be arranged along an outer circumferential side of the annular base portion facing away from the body portion of the user during use of the sealing arrangement.

The second flexible sleeve portion may be arranged along an inner circumferential side facing the user during use of the sealing arrangement.

Any one of the first and second flexible sleeve portions may be attached to the annular base portion.

The proximal portion of any one of one of the first and second flexible sleeve portions may comprise an essentially radially transparent region configured to permit a user to visually identify a portion of the annular flexible wearable layer within the annular space.

The second flexible sleeve portion may be configured to be foldable between an open position, in which the second flexible sleeve portion is arranged radially atop a portion of the annular base portion, and the sealing-connecting position, in which the second flexible sleeve portion is arranged radially atop a portion of the first flexible sleeve portion.

Each one of the annular base portion, first flexible sleeve portion and second flexible sleeve portion may be made of a flexible material. Examples of suitable flexible materials are thermoplastic elastomers (TPE), e.g. thermoplastic polyurethane (TPU), polyurethane, rubber or silicone. The rubber may e.g. be latex, synthetic rubbers, such as neoprene etc. Other flexible materials are also conceivable depending on type of garment and type of environment.

The annular base portion and the second flexible sleeve portion may be a one-piece module and the first flexible sleeve portion may be a separate part attached to the annular base portion. The sealing arrangement may be a one-piece module. By way of example, the annular base portion, the first flexible sleeve portion and the second flexible sleeve portion are moulded into a single piece. The one-piece module may be made by additive manufacturing.

In the sealing-connecting position, the difference between the inner circumference of the distal portion of the outer circumferential sleeve and the outer circumference of the distal portion of the inner circumferential sleeve provides a friction fit over a portion of the annular flexible wearable layer.

Hereby, by the difference, the second flexible sleeve portion exerts a pressure circumferentially around the first flexible sleeve portion resembling a pressure fit. As both the first and second flexible sleeve portions are joined to the same annular base member, there is obtained friction fit therebetween, such that the annular flexible material layer is hold in place and connected to the first and second flexible sleeve portions.

More specifically, when the second flexible sleeve portion is in the sealing-connecting position and the annular flexible wearable layer is arranged about the distal portion of the inner circumferential sleeve, the circumferential difference between the first and second flexible sleeve portions may provide a friction fit over a portion of the annular flexible wearable layer. In this context, the circumferential difference refers to the provision that the inner circumference of the distal portion of the outer circumferential sleeve being smaller than an outer circumference of the distal portion of the inner circumferential sleeve.

According to the third aspect thereof, there is provided a sealing assembly for garments to sealingly connect a sealing arrangement and an annular flexible wearable layer. The sealing assembly comprises the sealing arrangement and the annular flexible wearable layer. Further, the annular flexible wearable layer has a radial thickness (t) defined by an inner annular surface and an outer annular surface thereof. Also, the sealing arrangement comprises an annular base portion and a pair of first and second flexible sleeve portions extending from the annular base portion and configured to form corresponding first and second sealing connector portions, respectively, each one of the first and second flexible sleeve portions having a proximal portion and a distal portion in relation to the annular base portion, the proximal portions extending radially spaced apart from the annular base portion. Moreover, one of the first and second flexible sleeve portions is an outer circumferential sleeve and the other one of the first and second flexible sleeve portions is an inner circumferential sleeve. Further, at least at least an inner circumference of the distal portion of the outer circumferential sleeve is smaller than an outer circumference of the annular flexible wearable layer as measured when the annular flexible wearable layer being arranged about the distal portion of the inner circumferential sleeve. Moreover, the second flexible sleeve portion is configured to be turnable about an annular imaginary line and between an open position and a sealing-connecting position relative to the first flexible sleeve portion, in which at least a portion of the second flexible sleeve portion is superposed the first flexible sleeve portion. In addition, in the sealing-connecting position, the proximal portions may be configured to collectively define an intermediate annular space for accommodating a portion of the annular flexible wearable layer.

In the sealing-connecting position, the difference between the inner circumference of the distal portion of the outer circumferential sleeve and the outer circumference of the distal portion of the inner circumferential sleeve provides a friction fit over a portion of the annular flexible wearable layer. Hereby, by the difference, the second flexible sleeve portion exerts a pressure circumferentially around the first flexible sleeve portion resembling a pressure fit. As both the first and second flexible sleeve portions are joined to the same annular base member, there is obtained friction fit therebetween, such that the annular flexible material layer is hold in place and connected to the first and second flexible sleeve portions.

More specifically, when the second flexible sleeve portion is in the sealing-connecting position and the annular flexible wearable layer is arranged about the distal portion of the inner circumferential sleeve, the circumferential difference between the second flexible sleeve portion and the annular flexible wearable layer may provide a friction fit over a portion of the annular flexible wearable layer. In this context, the circumferential difference refers to the provision that the inner circumference of the distal portion of the outer circumferential sleeve being smaller than the outer circumference of the annular flexible wearable layer, as measured when the annular flexible wearable layer being arranged about the distal portion of the inner circumferential sleeve.

According to the fourth aspect thereof, there is provided a fluid-protective garment, such as a waterproof garment, a water-resistant garment, a diving suit, a dry suit, a protection suit, a wet suit or a work wear, comprising a first garment portion in the form of an annular flexible wearable layer and a second garment portion in the form of a sealing arrangement according to any one of the first and second aspects, wherein the sealing arrangement is configured to sealingly connect the annular flexible wearable layer

According to a fifth aspect thereof, there is provided a fluid-protective garment, such as a waterproof garment, a water-resistant garment, a diving suit, a dry suit, a protection suit, a wet suit or a work wear, comprising a sealing assembly according to the third aspect.

According to a sixth aspect thereof, there is provided a sealing arrangement for garments to sealingly connect with an annular flexible wearable layer. The sealing arrangement is obtained by: providing a first flexible sleeve portion having a proximal portion and a distal portion, the distal portion having an outer circumference, providing an annular base portion and a second flexible sleeve portion, the second flexible sleeve portion extending from the annular base portion, and further having a proximal portion and a distal portion in relation to the annular base portion, the distal portion ohaving an inner circumference, wherein the inner circumference is smaller than the outer circumference of the distal portion of the first flexible sleeve portion, and attaching the first flexible sleeve portion to the annular base portion, wherein the proximal portions of the first and second flexible sleeve portions extend radially spaced apart from the annular base portion. Alternatively, the sealing arrangement is obtained by providing an annular base portion and a first flexible sleeve portion, the first flexible sleeve portion extending from the annular base portion, and further having a proximal portion and a distal portion in relation to the annular base portion, the distal portion having an outer circumference, providing a second flexible sleeve portion having a proximal portion and a distal portion, the distal portion having an inner circumference, wherein the inner circumference is smaller than the outer circumference of the distal portion of the first flexible sleeve portion, and attaching the second flexible sleeve portion to the annular base portion, wherein the proximal portions of the first and second flexible sleeve portions extend radially spaced apart from the annular base portion. The obtained sealing arrangement by the examples above may comprise any one of the features and examples as mentioned above in relation to the other aspects.

Typically, the first flexible sleeve portion may comprise a sealing surface and the second flexible sleeve portion may comprise a corresponding sealing surface. Hence, the first flexible sleeve portion and the second flexible sleeve portion are configured to form corresponding first and second sealing connector portions by having corresponding sealing surfaces. Moreover, at least any one of a portion of the sealing surface of the first flexible sleeve portion and a portion of the sealing surface of the second flexible sleeve portion is arranged in contact with the annular flexible wearable layer, when the second flexible sleeve portion is in the sealing-connecting position, so as to form a fluid-tight seal configuration therebetween. The proximal portions of the first and second flexible sleeve portions may generally be arranged radially spaced apart from each other as well as extending radially spaced apart from the annular base portion.

The sealing arrangement provides for sealingly connecting tubular portions in a fluid-tight manner so as to seal against fluids, such as water on an outside of the sealing arrangement. That is, the sealing arrangement is configured to circumferentially connect disengagable tubular portions for sealing against fluid transfer through the interface between the tubular portions. In this manner, the sealing arrangement provides for an improved sealing arrangement, in which the sleeve portions making-up the system are both the primary load-bearing or load-transferring parts for handling forces being generated during use of the garment and mating sealing components for sealing the first tubular portion with the second tubular portion in an easy, yet reliable manner.

In particular, the sealing arrangement provides for maintaining the first tubular portion and the second tubular portion in a closed configuration when the portions are connected to each other, i.e. a connected configuration so as to permit the sealing arrangement to withstand any tensile forces generated under ordinary use of the garment by a wearer, whilst enabling complete separation of the annular wearable layer from the sealing arrangement when the second flexible sleeve portion is in the open position relative to the first flexible sleeve portion. Further, in the connected state, i.e. in a state where the sealing arrangement connects the first tubular portion to the second tubular portion, the sealing arrangement can withstand a relatively high external force without losing its sealing properties. Further, in the connected state, the sleeve portions form the fluid-tight seal configuration by means of the friction fit configuration and the sealing surfaces of the sleeve portions and the annular wearable layer. In the open position, i.e. a disconnected state, the first tubular portion can be disconnected from the second tubular portion. It should be noted that the term “open position” may also be referred to as a non-sealing-connecting position, in which the annular wearable layer of another garment portion is allowed to be annularly positioned in-between the first and second flexible sleeve portions.

More specifically, by the provision of having a sealing arrangement configured to circumferentially connect the first tubular garment portion with the second tubular garment portion, there is formed a connected configuration so as to prevent, or at least substantially reduce, generation of relative movement between the first tubular portion and the second tubular portion in the connected state of the sealing arrangement. In this context, the term “relative movement” generally refers to a relative movement in a height direction (i.e. axial direction) of the reclosable sealing arrangement. The height direction refers to the height direction as defined with conventional cylindrical coordinates.

To this end, the sealing arrangement provides for an easy connection of the first tubular portion to the second tubular portion, while providing improved sealing properties thanks to the configuration of the friction fit configuration, as described herein. In this manner, the sealing arrangement provides for a reliable connection between annular portions of the garment as well as a reliable fluid-tight connection between the annular portions of the garment during use thereof.

The sealing arrangement, in particular tubular portions thereof, are particularly suited for encircling a portion of a limb, a portion of the torso (a portion of an upper body part), a portion of the neck of a user in order to provide a fluid-tight seal configuration at the sealing arrangement, e.g. for use as parts of a diving suit, dry suit, work wear or the like. The example embodiments of the sealing arrangement can be used in several different types of garments, including, but not limited to garments for weather protection, fluid-protective garments, such as waterproof garments, water-resistant garments, diving suits, dry suits, protection suits, wet suits, work wear, and other clothing for sport and leisure (e.g. waders and fishing garment suits). The example embodiments of the sealing arrangement may typically also be used for relatively light-weight garments such as e.g. waterproof jackets, and/or to garments which may be subject to high external forces such as e.g. off-shore applications.

Typically, as mentioned above, the sealing arrangement should be designed to be flexible or bendable enough to facilitate connection of the components of the sealing arrangement. Thus, the components of the sealing arrangement are generally provided in materials having relatively high bendable properties so as to provide for a comfortable use when incorporated in a garment such as diving suit, dry suit, work wear or the like.

The fluid-tight seal configuration is provided by the friction fit between the sleeve portions and the annular wearable layer in the connected state. The friction fit may be provided by the circumferential difference between the outer sleeve portion and the circumference of the annular wearable layer and the inner sleeve portion, i.e. the measure circumference of the annular layer when it is arranged about the inner sleeve portion. In this manner, the fluid-tight seal configuration is mutually formed along the circumferential direction when circumferentially inter-connecting the sleeve portions with the annular wearable layer.

The intermediate annular space for accommodating an annular portion of the annular wearable layer, as described herein, may further improve the fluid-tight configuration formed when the annular space accommodates the annular portion circumferentially around the sealing arrangement. In this manner, there is provided an improved arrangement of the fluid-tight configuration in that the annular space contributes to further maintain the tubular portions closer to each other, which is particularly useful if the sealing arrangement is subject to heavy external forces in different directions.

The sealing arrangement may generally have an inner surface facing the user during use and an outer surface facing away from the user during use. Hence, the second tubular portion may typically have an inner surface facing the user during use and an outer surface facing away from the user during use. Analogously, the first tubular portion may generally have an inner surface facing the user during use and an outer surface facing away from the user during use. Analogously, the annular wearable layer may generally have an inner surface facing the user during use and an outer surface facing away from the user during use.

According to one example embodiment, the first tubular portion comprises the annular flexible wearable layer and the second tubular portion comprises the sealing arrangement.

According to one example embodiment, the first tubular portion consists of the annular flexible wearable layer. Analogously, the second tubular portion consists of the sealing arrangement.

The first flexible sleeve portion may be directly attached to the annular base portion and the second flexible sleeve portion may be directly attached to the annular base portion.

According to one example embodiment, the annular base portion is a portion of a garment material, wherein the first and second flexible sleeve portions are attached to opposite sides of the portion of the garment material.

Typically, each one of the components of the sealing arrangement may be circumferentially attached to another component by adhesive means, welding, moulding, casting, and/or laces. According to one example embodiment, the first flexible sleeve portion is attached to the inner surface of the annular base portion. Thus, the first flexible sleeve portion is an integral part of the annular base portion. Analogously, the second flexible sleeve portion is attached to the outer surface of the annular base portion. Thus, the second flexible sleeve portion is an integral part of the annular base portion.

The first flexible sleeve portion may likewise be attached to the inner surface of the second tubular portion forming the annular base portion. Hence, the first flexible sleeve portion is an integral part of the inner circumferential edge portion of the second tubular portion. The second flexible sleeve portion may be attached to an outer circumferential edge portion of the second tubular portion. Hence, the second flexible sleeve portion is an integral part of the outer circumferential edge portion of the second tubular portion.

The annular shape of the sealing arrangement and its various parts are to be understood as ring-shaped, i.e. as formed/shaped around an origin. In other words, the annular shape of the tubular portions, the first and second flexible sleeve portions and the annular wearable layer are generally ring-shaped. The annular shape may e.g. be circular, essentially circular, oval, elliptical or formed in any other annular form. Thus, the sealing arrangement may be formed to fit around a portion of a body e.g. the waste of a human, limbs of a human, such as e.g. the neck, arms, hands, legs and wrists of a human.

The sealing arrangement has an extension in the circumferential direction. It should also be understood that the sealing arrangement, and its related parts generally have an extension in the circumferential direction, i.e. in a direction around a periphery of the sealing arrangement, and an extension in the radial direction, i.e. in a direction perpendicular to the circumferential direction and directing from an inner annular surface of the sealing arrangement towards an outer annular surface of the sealing arrangement. In other words, the sealing arrangement, and its parts, may be described with cylindrical coordinates (C, R, Z), the circumferential direction corresponding to the direction of the angle C of the angular coordinate C, the radial direction corresponding to a direction in the radial distance R, and the direction perpendicular to both the circumferential direction and the radial direction corresponding to a direction along the height Z.

It should be understood that the first and second flexible sleeve portions are adapted to connect with the annular wearable layer along the entire circumference of the sealing arrangement. In addition, it should be understood that the first and second flexible sleeve portions are generally arranged to form the friction fit and the sealing configuration along the entire circumference of the sealing arrangement in order to seal the body part of the user from its surroundings.

The sealing arrangement, in particular the main part of the sealing arrangement, favourably comprises a material that is suitable for use in garments subjected to constant humidity, water or a gas pressure. Such materials are known in the art. Favourably such materials are stretchable, so that they can readily adapt to the shape of the relevant body part (e.g. leg, arm, wrist, neck, etc.). Thus, according to one example embodiment, the sealing arrangement is a flexible sealing arrangement. By way of example, the first and second flexible sleeve portions can be made from a flexible material e.g. plastic such as thermoplastic polyurethane (TPU), polyurethane, or rubber or silicone. The material should typically be selected based on the purpose of the fluid-tight seal configuration and the type of garment. Thus, according to at least one example embodiment, each one of the components of the sealing arrangement may comprise a flexible material e.g. plastic such as thermoplastic polyurethane (TPU), polyurethane, or rubber or silicone.

According to at least one example embodiment, the sealing arrangement is moulded, e.g. injection-moulded or casted. Analogously, each one of the tubular portions may be moulded, e.g. injection-moulded or casted.

In the context of the present disclosure, the term “fluid” in the term fluid-tight seal configuration may refer to any type of fluid, including, but not limited to liquid fluids and gaseous fluids. By way of example, the liquid fluid is water. One example of a gaseous fluid is water vapor. Another example of a gaseous fluid is air. It is to be noted that the fluid-tight seal configuration refers to a configuration between first and second flexible sleeve portions and the annular wearable layer that seals against fluid at least when the components are formed into the friction fit configuration. In one example embodiment, the fluid-tight seal configuration seals at least against any one of liquid fluids and gaseous fluids. In another example embodiment, the fluid-tight seal configuration seals at least against any one of water and water vapor. In yet another example embodiment, the fluid-tight seal configuration seals at least against any one of water, water vapor and air. In still another example embodiment, the fluid-tight seal configuration seals at least against air.

The sealing arrangement may be used to connect two portions of a garment, such as two tubular wearable layers of the garment to each other. For example, the neck portion of a jacket or diving suit may be sealingly connected to an annular surface of a helmet, the neck portion including the tubular portion. It is to be noted that each one of the first and second tubular portions may be separate portions of the sealing arrangement of the garment. In addition, or alternatively, each one of the first and second tubular portions may be integral portions of the sealing arrangement, wherein each one of the first and second tubular portions of the sealing arrangement extends into a first and second garment portions of the garment, respectively. Alternatively, each one of the first and second tubular portions may be separate portions of the sealing arrangement, wherein each one of the first and second tubular portions are fixedly attached to first and second garment portions, respectively, of the garment. In all these examples, the sealing arrangement provides for sealingly and circumferentially connecting the first tubular portion of a garment with a second tubular portion (of the garment) in an easy, yet reliable manner. The first tubular portion and the second tubular portion are typically separable parts of the garments. However, the sealing arrangement for garments should be understood to at least include the use of one of the tubular portions to connect to a portion of the garment by means of the sealing arrangement. Accordingly, it should be readily appreciated that the sealing arrangement is generally a portion of a garment.

The above aspects, accompanying claims, and/or examples disclosed herein, above and later below may be suitably combined with each other as would be apparent to anyone of ordinary skill in the art.

Further features of, and advantages with, the example embodiments will become apparent when studying the appended claims and the following description. The skilled person realize that different features of the example embodiments may be combined to create variants and example embodiments other than those described in the following, without departing from the scope of the present disclosure, as defined by the appended claims.

### BRIEF DESCRIPTION OF THE DRAWINGS

With reference to the appended drawings, below follows a more detailed description of embodiments of the disclosure cited as examples.

FIG. 1 schematically illustrates a garment for a wearer comprising a number of sealing arrangements; in which parts of the garments are sealingly connected to each other;

FIG. 2a shows a schematic illustration of a partly cross-sectional perspective view of a sealing arrangement when parts of the sealing arrangement are in an orientation prior to engagement with an axially opposite wearable material, and which may reflect a first stage in the process of sealingly connecting the parts of the sealing arrangement to the wearable material;

FIG. 2b shows a schematic illustration of a perspective view of the sealing arrangement, where a portion of one of the flexible sleeve portions of the sealing arrangement is folded over an annular base portion of the sealing arrangement to permit an arrangement of the axially opposite wearable material in-between first and second flexible sleeve portions, and which may reflect a second stage of the process of sealingly connecting the sealing arrangement to the wearable material;

FIG. 2c shows a schematic illustration of a perspective view of the sealing arrangement, where the axially opposite wearable material is completely annularly positioned around and arranged in contact with the first flexible sleeve portion, and which may reflect a third stage of the process of sealingly connecting the sealing arrangement to the wearable material;

FIG. 2d shows a schematic illustration of a perspective view of the sealing arrangement, wherein the second flexible sleeve portion has been turned and folded over the first flexible sleeve portion whereby the sealing arrangement forms an annularly connected and closed fluid-tight seal configuration so as to maintain the wearable material sealingly connected to sealing arrangement, and which forms a fourth and final stage of the process of sealingly connecting the sealing arrangement to the wearable material;

FIG. 3 schematically illustrates another example embodiment of a sealing arrangement according to the disclosure;

FIG. 4 schematically illustrates an enlarged side view of sealing arrangement in FIGS. 2a to 2d, in which the annular wearable material is fully inserted and annularly positioned radially in-between the first and second flexible sleeve portions;

FIG. 5a shows a schematic illustration of a perspective view of the sealing arrangement in FIGS. 2a to 2d, in which the enlarged views in FIG. 5a schematically illustrate a number of examples of a friction fit provided by the first and second flexible sleeve portions in a connected state with the wearable material;

FIG. 5b shows a schematic illustration of a perspective view of the sealing arrangement in FIGS. 2a to 2d, in which the enlarged views in FIG. 5b schematically illustrate a number of examples of a friction fit provided by the first and second flexible sleeve portions in a connected state with the wearable material;

FIGS. 6a to 6d schematically illustrate a number of examples of annular wearable materials intended for sealingly connecting with the sealing arrangement to form the fluid-tight seal configuration; and

FIGS. 7a to 7f schematically illustrate a number of examples of the first and second flexible sleeve portions intended for sealingly connecting with the annular wearable material to form the fluid-tight seal configuration.

### DETAILED DESCRIPTION OF EXAMPLE EMBODIMENTS

The present disclosure will now be described more fully hereinafter with reference to the accompanying drawings, in which exemplary embodiments of the disclosure are shown. The disclosure may, however, be embodied in many different forms and should not be construed as limited to the embodiment set forth herein; rather, these embodiments are provided for thoroughness and completeness. Like reference character refer to like elements throughout the description.

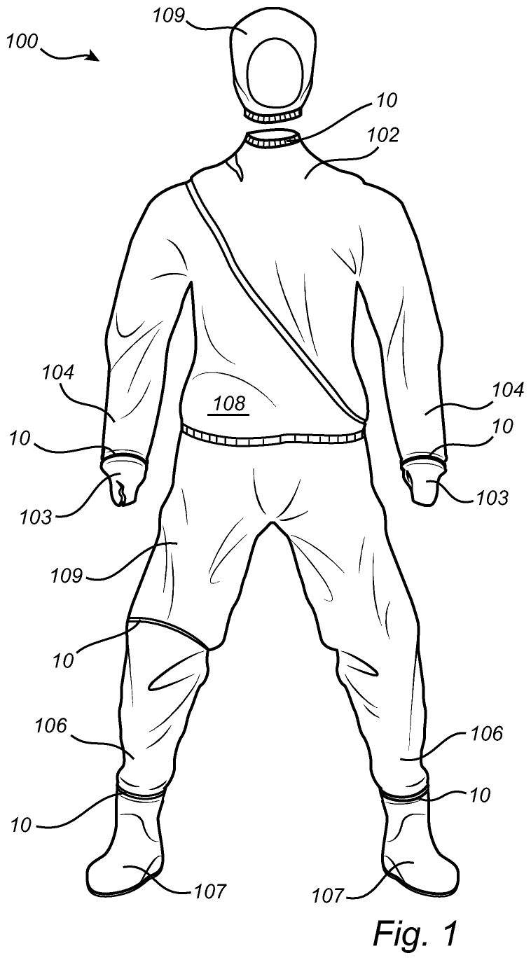

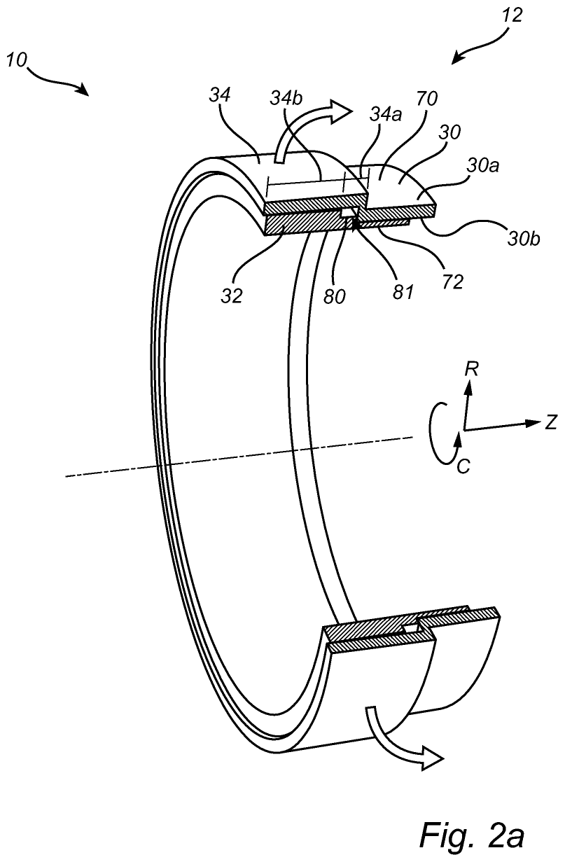

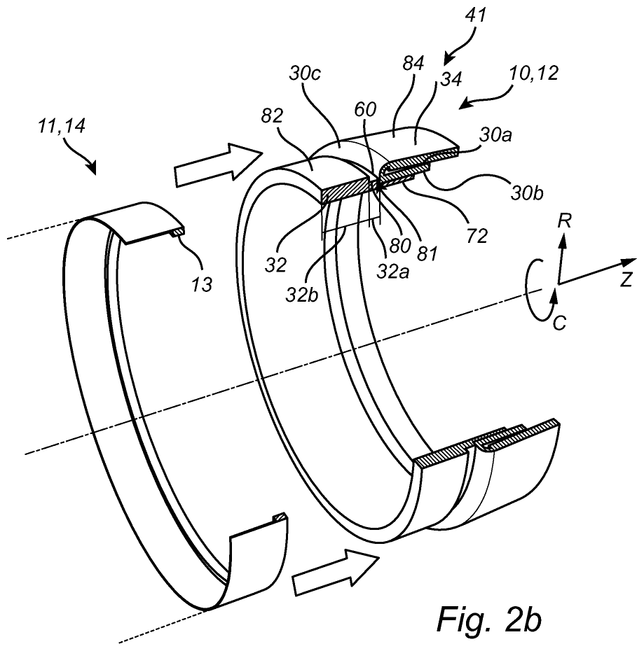

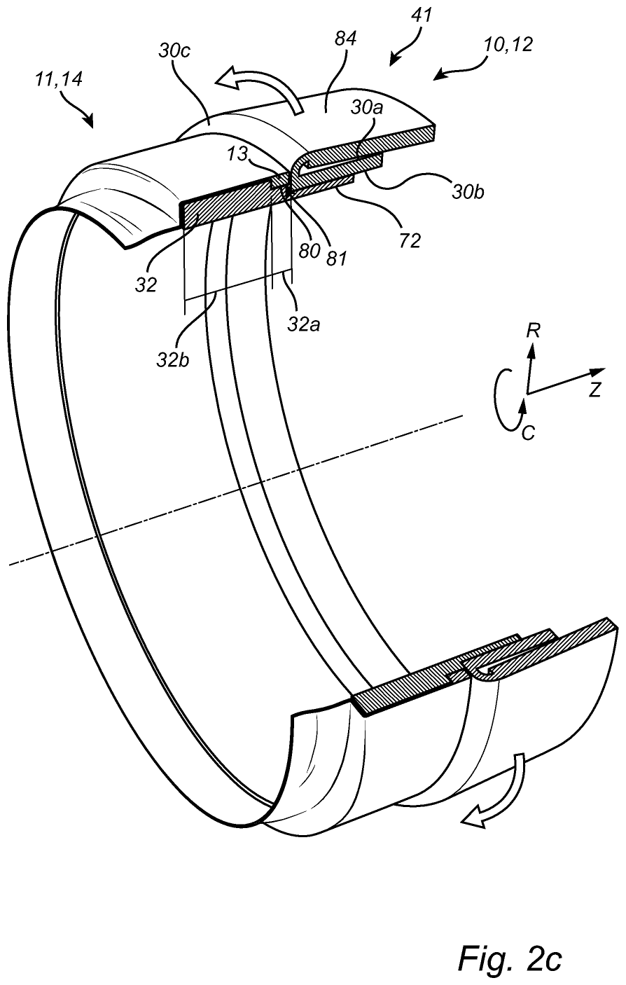

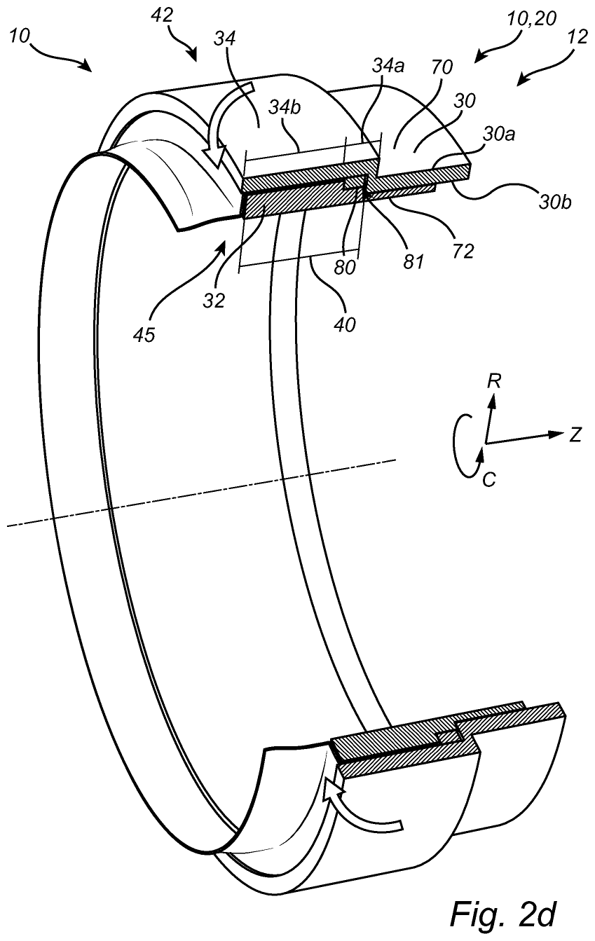

In FIG. 1 of the drawings an example embodiment of a garment 100 is schematically illustrated in an assembled state. FIG. 1 illustrates a garment 100, for instance a dry suit or a diving suit, comprising a number of sealing arrangements 10 according to any one of the example embodiments of the disclosure. The garment may likewise be a jacket, e.g. a rain jacket, and pants. As may be gleaned from FIG. 1, a neck portion 102, cuffs of the arms 104, wrists of the legs 106, and a waistline 108 are provided with such sealing arrangements 10. The neck portion 102 and the waistline portion 108 are typically provided with a relatively larger type of sealing arrangement 10 as will be described in relation to any one of the example embodiments illustrated in FIGS. 2a to 7f, while the cuffs of the arms 104 and the wrists 106 of the pants typically are provided with a sealing arrangement 10 of a relatively smaller size, as will be described in relation to any one of the example embodiments illustrated in relation to FIGS. 2a to 7f.

For the neck portion 102, the sealing arrangement 10 may sealingly connect the neck portion 102 to a helmet 101 around its periphery. As such, the neck portion 102 is circumferentially- and sealingly connected to the helmet 101 by means of the sealing arrangement 10, as will be further described in relation to any one of the example embodiments illustrated in FIGS. 2a to 7f. Analogously, the waistline of an upper body part 108 of the dry suit (or a jacket of a work wear) and a waistline of a lower part 109 of the dry suit (or a pair of pants) are circumferentially- and sealingly connected to each other around its periphery by means of the sealing arrangement 10, as will be further described in relation to any one of the example embodiments illustrated in FIGS. 2a to 7f. Analogously, the cuffs 104 of the arms of the dry suit and hand seals 103, or gloves, are sealingly connected to each other around its periphery by means of the sealing arrangement 10, as will be further described in relation to any one of the example embodiments illustrated in FIGS. 2a to 7f. Analogously, a wrist 106 of the dry suit (or pants) and e.g. a boot 107 are sealingly connected to each other around its periphery by means of the sealing arrangement 10, as will be further described in relation to any one of the example embodiments illustrated in FIGS. 2a to 7f. Analogously, two portions of the pants, e.g. a lower portion of one leg portion and an upper portion of the leg portion may be sealingly and circumferentially connected to each other around its periphery via the sealing arrangement 10, as will be further described in relation to any one of the example embodiments illustrated in FIGS. 2a to 7f. It is to be noted that the sealing arrangement 10 can be used together with a wide range of different types of garment portions, especially with a wide range of differently sized annular garment portions. The above description may likewise be applicable to a garment comprising a jacket and a pair of pants. In other words, there is provided a garment 100, such as diving suit or dry suit having an outer garment formed from a plurality of tubular portions interconnected by one or several sealing arrangements to inhibit ingress of fluid, such as water, thereto.

With particular reference to FIGS. 2a to 7f, there are depicted various example embodiments of a sealing arrangement 10 for use with the garment 100 in FIG. 1.

One example of a sealing arrangement for use with or in the garment 100 in FIG. 1 will now be further described in relation to FIGS. 2a to 2d, FIG. 4 and FIGS. 5a and 5b.

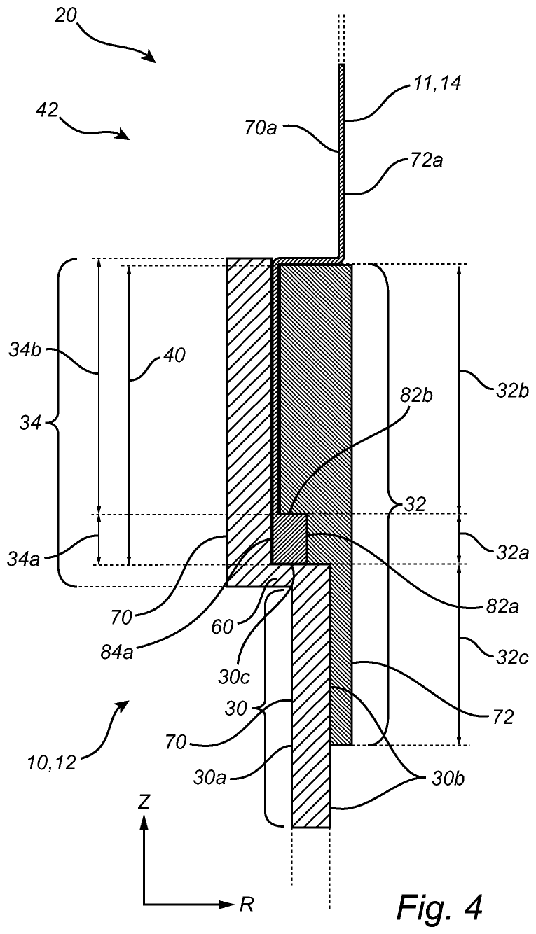

As illustrated in the figures, e.g. FIGS. 2a to 2d, the sealing arrangement 10, and its related parts, have an extension in a circumferential direction C, i.e. in a direction around a periphery of the sealing arrangement 10, an extension in a radial direction R, i.e. in a direction perpendicular to the circumferential direction C and directing from an inner surface 72 (see e.g. FIG. 2a and FIG. 4) towards an outer surface 70 (see FIG. 4). The inner surface 72 typically corresponds to an inside of the sealing arrangement 10, while the outer surface 70 typically corresponds to the outside of the sealing arrangement 10. In other words, the sealing arrangement 10 may be described with conventional cylindrical coordinates, the circumferential direction corresponding to the direction of the angle C of the angular coordinate C, the radial direction corresponding to a direction of the radial distance R, and the direction perpendicular to both the circumferential direction and the radial direction corresponding to a longitudinal direction Z. Accordingly, the sealing arrangement 10 has an extension in the longitudinal direction Z, that may generally be denoted as an axial direction of the sealing arrangement, and as also illustrated in e.g. FIG. 2a and/or FIG. 4. Hence, the term “longitudinal”, “longitudinally”, “axially” or “axial” refer to a direction extending along the sealing arrangement or components thereof. The longitudinal direction Z may generally also refer to the direction of the extension of the body part surrounded by the sealing arrangement 10 during use. Further, the terms “circumference”, “circumferential”, or “circumferentially” refer to a circumference or a circumferential direction relative to an axis, typically a central axis extending in the longitudinal direction Z of sealing arrangement 10 and/or components thereof. Similarly, “radial” or “radially” refer to a direction extending radially relative to the axis.

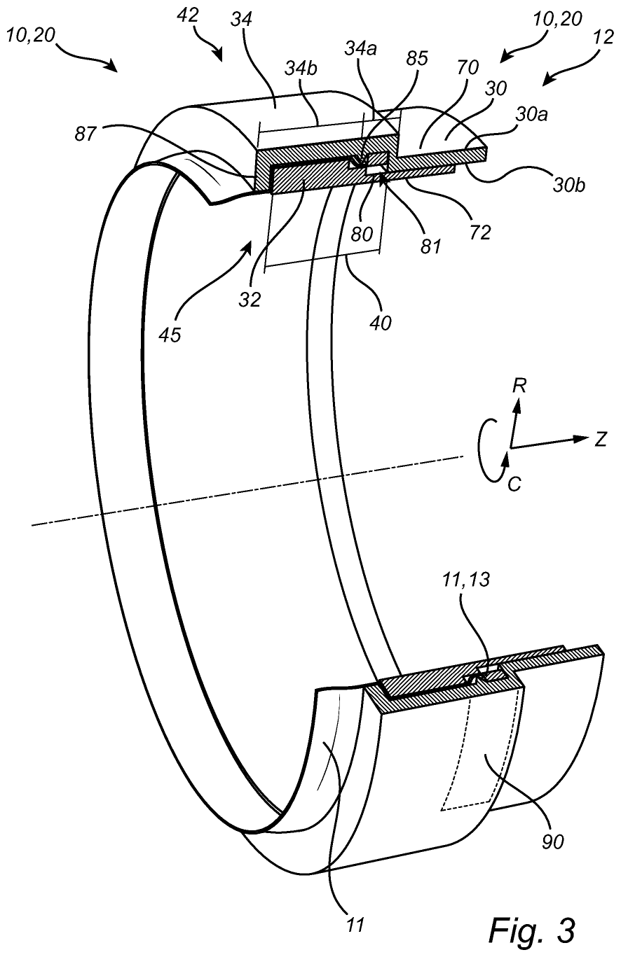

It is to be noted that some components may be enlarged in relation to other components in order to facilitate the understanding of the example embodiments. Further, for ease of reference, the sealing arrangement may sometimes only be denoted as the arrangement. Moreover, as described herein, the system of the sealing arrangement and a part of the garment in the form of an annular flexible wearable material 11 may generally be denoted as a sealing assembly 20, see e.g. FIG. 3 and FIG. 4. FIG. 4 depicts the sealing arrangement 10 in a sealing-connecting position 42 with the annular flexible wearable layer 11. The sealing arrangement 10 and the annular flexible wearable material 11 here form the sealing assembly 20.

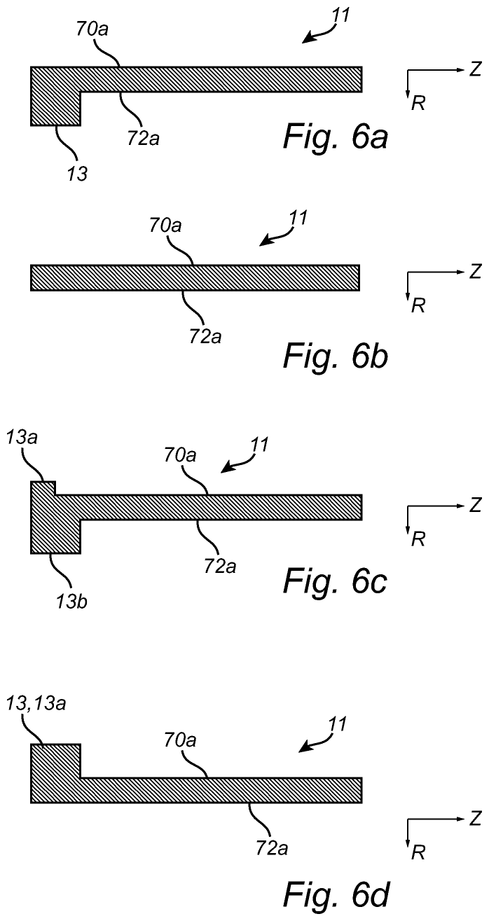

As illustrated in e.g. FIGS. 2a to 2d and FIG. 4, the sealing arrangement 10 is here defined by a first tubular portion 12 and the annular flexible wearable material 11 defined by a second tubular portion 14 for encircling a body portion of a user during use of the sealing arrangement in the garment 100 in FIG. 1. The tubular portions 12 and 14 may be extensions of tubular portions of the garment, as illustrated in FIG. 1, such as tubular portions of a dry suit. Thus, the sealing arrangement 10 is here a part of the first tubular portion 12 for encircling a body portion of a user and the annular flexible wearable material 11 is part of the second tubular portion 14 for encircling the body portion of the user. By way of example, the first tubular portion 12 is adapted to encircle an arm of the user while the second tubular portion 14 is adapted to be a part of dry suit glove. The sealing arrangement 10 further comprises the outer circumferential surface 70 and the inner circumferential surface 72, as illustrated in e.g. FIG. 2a and/or FIG. 4. The outer circumferential surface 70 is facing away from the body portion (not shown) of the user during use of the sealing arrangement 10. The inner circumferential surface 72 is facing towards the user during use of the sealing arrangement 10. Analogously, the annular wearable material 11 comprises corresponding inner circumferential surface 72a and outer circumferential surface 70a (FIG. 4 and FIGS. 6a to 6d).

In other words, the first tubular portion 12 and the second tubular portion 14 are separable portions relative each other. That is, the first tubular portion 12 and the second tubular portion 14 are disengagable from each other. Further, the first tubular portion 12 and the second tubular portion 14 are inter-connectable to each other to form a circumferential connection between the first tubular portion 12 and the second tubular portion 14 so as to provide a reclosable sealing arrangement.

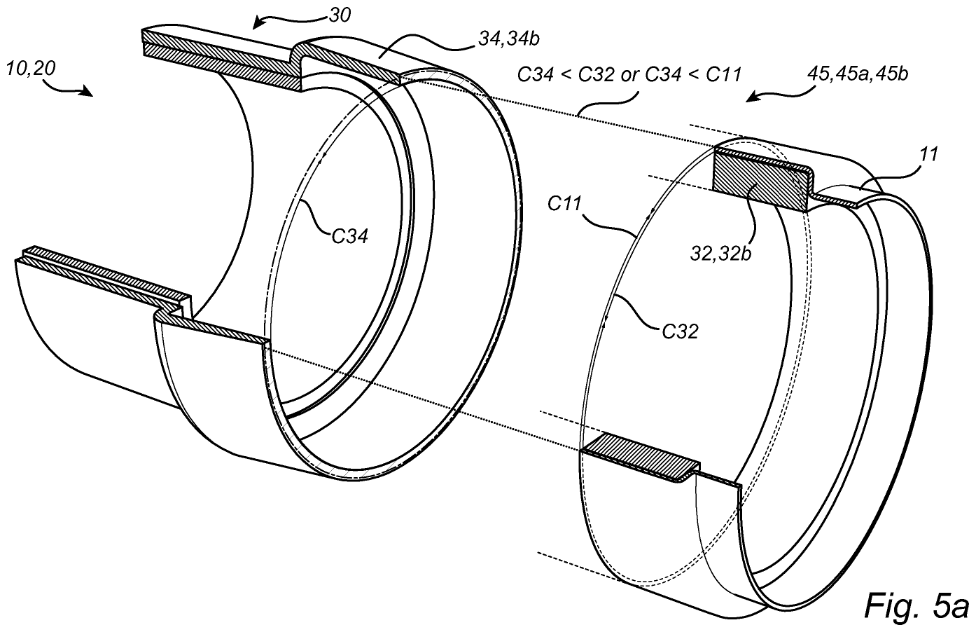

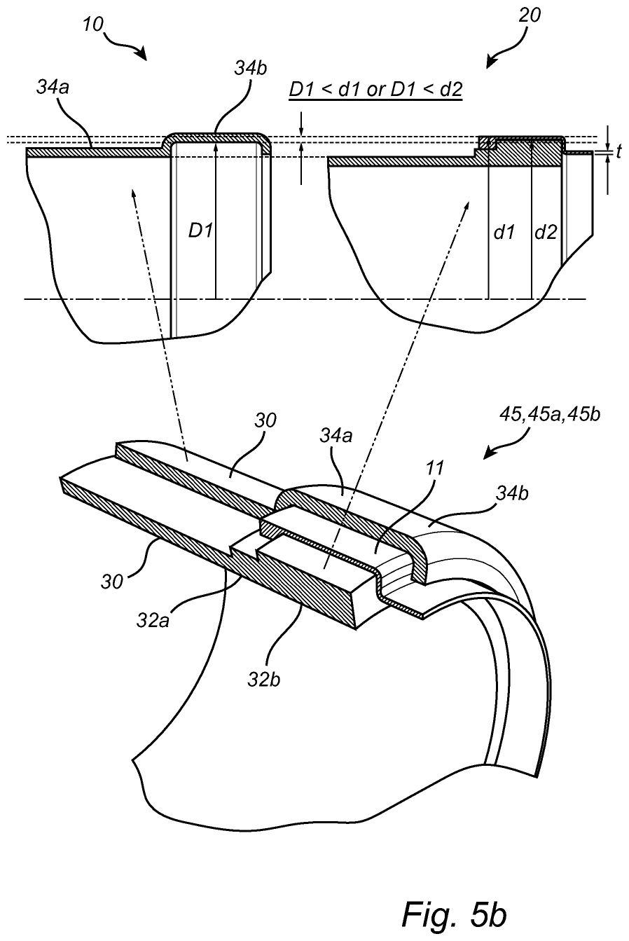

In order to inter-connect the first tubular portion 12 and the second tubular portion 14, the first tubular portion 12 comprises the sealing arrangement 10 and the second tubular portion 14 comprises the annular flexible wearable material 11, as seen in the examples illustrated in e.g. FIG. 2d, FIG. 3, FIG. 4 and FIGS. 5a and 5b. It should be readily appreciated that the opposite arrangement may also be conceivable. In other words, the first tubular portion 12 may comprise the annular flexible wearable material 11 and the second tubular portion 14 may comprise the sealing arrangement 10.

Turning now to FIGS. 2a to 2d in conjunction with FIG. 4, there is depicted one example of the sealing arrangement 10 for garments. As illustrated in figs. FIGS. 2a to 2d and FIG. 4, the sealing arrangement 10 is adapted to sealingly connect with the annular flexible wearable layer 11.

The sealing arrangement 10 comprises an annular base portion 30. The annular base portion 30 is made of a flexible material. When the sealing arrangement 10 is used around the body portion of the user, the annular base portion 30 extends circumferentially around the first tubular portion 12. The sealing arrangement 10 further comprises a first flexible sleeve portion 32 and a second flexible sleeve portion 34. The first flexible sleeve portion 32 and the second flexible sleeve portion 34 forms a pair of first and second flexible sleeve portions. The first flexible sleeve portion 32 and the second flexible sleeve portion 34 are each made of a flexible material. The first flexible sleeve portion 32 extends from the annular base portion 30. Further, the first flexible sleeve portion 32 generally extends circumferentially around the annular base portion 30. When the sealing arrangement 10 is used around the body portion of the user, the first flexible sleeve portion 32 generally extends circumferentially around the first tubular portion 12. When the sealing arrangement 10 is used around the body portion of the user, the first flexible sleeve portion 32 faces the body portion (not shown) of the user during use.

Analogously, the second flexible sleeve portion 34 extends from the annular base portion 30. Further, the second flexible sleeve portion 34 generally extends circumferentially around the annular base portion 30. When the sealing arrangement 10 is used around the body portion of the user, the second flexible sleeve portion 34 thus extends circumferentially around the first tubular portion 12. When the sealing arrangement 10 is used around the body portion of the user, the second flexible sleeve portion 34 faces away from the body portion (not shown) of the user during use.

Moreover, as illustrated in FIGS. 2a to 2d, the first flexible sleeve portion 32 and the second flexible sleeve portion 34 are arranged radially spaced apart from each other. In other words, the first flexible sleeve portion 32 and the second flexible sleeve portion 34 extend radially spaced-apart from each other and extend radially spaced away from the annular base portion 30. By way of example, as illustrated in FIGS. 2a to 2d, the second flexible sleeve portion 34 and the annular base portion 30 are integral parts, while the first flexible sleeve portion 32 is securely attached to the annular base portion 30 on a radially opposite side of the annular base portion 30 than the location of the second flexible sleeve portion 34. Accordingly, the annular base portion 30 and the second flexible sleeve portion 34 are here a one-piece module and the first flexible sleeve portion 32 is a part securely attached to the annular base portion 30. Other types of arrangements of the first and second flexible sleeve portions 32, 34 are also conceivable, as described herein.

Further, as illustrated in FIGS. 2a to 2d and FIG. 4, the second flexible sleeve portion 34 is an outer circumferential sleeve and the first flexible sleeve portions 32 is an inner circumferential sleeve. The terms outer circumferential sleeve and inner circumferential sleeve are here defined in relation to the radial direction R.

By means of the arrangement of the first flexible sleeve portion 32 and the second flexible sleeve portion 34, the sealing arrangement 10 is configured to circumferentially inter-connect the first tubular portion 12 with the annular wearable material 11 of the second tubular portion 14, as further described hereinafter.

In addition, as illustrated in FIGS. 2a to 2d and FIG. 4, the first flexible sleeve portion 32 comprises a sealing surface 82. Analogously, the second flexible sleeve portion 34 comprises a sealing surface 84. As such, the first flexible sleeve portion 32 and the second flexible sleeve portion 34 are configured to form corresponding first and second sealing connector portions, respectively.

In the sealing-connecting position 42 with the annular flexible wearable material 11, as illustrated in FIG. 2d and also in FIG. 4, at least a portion of the sealing surface 82 of the first flexible sleeve portion 32 and at least a portion of the sealing surface 84 of the second flexible sleeve portion 34 are arranged in contact with a portion of the annular flexible wearable material 11 to form a fluid-tight seal configuration 40. In other words, in the fluid-tight sealing configuration of the sealing arrangement 10 with the annular flexible wearable layer 11, corresponding to the sealing-connecting position 42, the first flexible sleeve portion 32 and the second flexible sleeve portion 34 are circumferentially connected to the annular wearable material 11, as illustrated in e.g. FIG. 4. The sealing surfaces 82, 84 are thus arranged on the first flexible sleeve portion 32 and the second flexible sleeve portion 34, respectively, to provide a fluid-tight sealing in cooperation with the annular flexible wearable material 11 when they are in the connected state.

Moreover, as depicted in e.g. FIG. 4, the first flexible sleeve portion 32 comprises a proximal portion 32a and a distal portion 32b in relation to the annular base portion 30. Analogously, the second flexible sleeve portion 34 comprises a proximal portion 34a and a distal portion 34b in relation to the annular base portion 30.

The terms proximal and distal generally refer to the orientation of the portions 32, 34 as depicted in e.g. FIG. 4, i.e. when the sealing arrangement 10 is in the sealing-connecting position 42. In the present disclosure, when the term “distal direction” is used, this refers to the direction pointing away from the annular base portion 30 during use of the sealing arrangement 10, i.e. in a configuration/state, as depicted in FIG. 4. When the term “distal portion” is used, this refers to the part/end of the sealing arrangement, or the parts/ends of the sleeve portions thereof, which under use of the sealing arrangement 10 is/are located furthest away from the annular base portion 30, as depicted in FIG. 4. Correspondingly, when the term “proximal direction” is used, this refers to the direction pointing towards the annular base portion 30 during use of the sealing arrangement 10, as depicted in FIG. 4. When the term “proximal portion” is used, this refers to the part/end of the sealing arrangement 10, or the parts/ends of the sleeve portions thereof, which under use of the sealing arrangement is/are located closest to the annular base portion 30, as depicted in FIG. 4.

The proximal portions 32a, 34a of the first and second flexible sleeve portions 32, 34 extend radially spaced apart from the annular base portion 30, respectively. In other examples, the distal portions 32b, 34b of the first and second flexible sleeve portions 32, 34 may be arranged radially spaced apart from each other. It should be noted that the above orientation of the portions 32, 34 refers to the arrangement of the portions 32, 34 when the sealing arrangement 10 is in the sealing-connecting position 42, as depicted in FIG. 4.

The second flexible sleeve portion 34 is arranged along an outer circumferential side 30a of the annular base portion 30 facing away from the body portion of the user during use of the sealing arrangement 10. Further, the first flexible sleeve portion 32 is arranged along an inner circumferential side 30b of the annular base portion 30 facing the body portion of the user during use of the sealing arrangement 10. In the example of the sealing arrangement 10 in FIGS. 2a to 2d and FIG. 4, the first flexible sleeve portion 32 also comprises an additional attachment portion 32c extending axially over the annular base portion 30 and adapted to be securely attached to the inner circumferential side 30b of the annular base portion 30 by means of adhesive, welding or the like. It should be readily appreciated that the first flexible sleeve portion 32 may in some examples be an integral part of the annular base portion 30. Hence, the first flexible sleeve portion may be defined only by the proximal and distal portions 32a, 32b.

Moreover, as illustrated by the arrows in e.g. FIGS. 2a, 2c and 2d, the second flexible sleeve portion 34 is here foldable between an open position 41 (see FIG. 2c) and the sealing-connecting position 42 (see FIG. 2d and FIG. 4). In the sealing-connecting position 42, at least a portion of the second flexible sleeve portion 34 is superposed the first flexible sleeve portion 32. The second flexible sleeve portion 34 is arranged superposed the first flexible sleeve portion 32 entirely around the circumferential direction C of the sealing arrangement 10. In addition, the second flexible sleeve portion 34 is arranged atop the first flexible sleeve portion 32, as seen in the radial direction R. The open position 41 thus refers to a non-sealing position (or non-connecting position), in which the annular flexible wearable layer 11 is allowed to be annularly positioned in-between the first and second flexible sleeve portions 32 and 34, as illustrated in e.g. FIG. 2b. In the open position 41, also denoted as the non-connecting position, the second flexible sleeve portion 34 is generally folded into a position radially outwardly from the annular base portion 30. It should be noted that the second flexible sleeve portion 34 may not necessarily be folded completely to the position indicated in FIG. 2b. Rather, it may be sufficient that the second flexible sleeve portion 34 is turnable to an open position such that the annular flexible wearable layer 11 can be positioned annularly about the outer surface (e.g. the sealing surface 82) of the first flexible sleeve portion 32 and radially in-between the first and second flexible sleeve portions 32 and 34.

Further, as illustrated in e.g. FIG. 4, an intersection between the second flexible sleeve portion 34 and the annular base portion 30 defines an imaginary line 60 extending circumferentially around the annular base portion 30. The imaginary line 60 here indicates a folding region defining a fold line to indicate one example of where the second flexible sleeve portion 34 is foldable about the annular base portion. In other words, as illustrated in FIG. 4, the second flexible sleeve portion 34 here defines the annular imaginary line 60, in which at least a part of the second flexible sleeve portion 34 is foldable about when a user of the garment intends to use the sealing arrangement 10. As such, the second flexible sleeve portion 34 is configured to be turnable about the annular imaginary line 60. More specifically, the second flexible sleeve portion 34 is foldable over the annular base portion 30 to the open position 41, in which a part of the second flexible sleeve portion 34 is arranged atop of the annular base portion 30. In addition, the second flexible sleeve portion 34 is foldable from the open-position 41 to the sealing-connecting position 42, in which the second flexible sleeve portion 34 is superposed the first flexible sleeve portion 32. Depending on the dimensions of the components of the sealing arrangement 10, the folding region may be located in the intersection between the annular base portion 30 and the second flexible sleeve portion 34, at the annular base portion 30 or at the proximal portion 34a of the second flexible sleeve portion 34.

As indicated in e.g. FIGS. 2d and 4, illustrating the first and second flexible sleeve portions 32 and 34 in the sealing-connecting position 42, the first and second flexible sleeve portions 32 and 34 in this position collectively form the fluid-tight seal configuration 40 with the annular flexible wearable layer 11 arranged annularly about the outer surface (e.g. the sealing surface 82) of the first flexible sleeve portion 32 and radially in-between the first and second flexible sleeve portions 32 and 34.

Further as illustrated in FIGS. 2a to 2d, and also in FIG. 4, the proximal portions 32a, 34a are configured to collectively define an intermediate annular space 80 for accommodating a portion of the inserted annular flexible wearable layer 11.

It is to be noted that the annular space 80 can be provided in several different ways. In the example in FIGS. 2a to 2d and FIG. 4, the intermediate annular space 80 is defined by sealing surfaces 82, 84 of the proximal portions 32a, 34a of the first and second flexible sleeve portions 32, 34 together with an abutment surface 30c of the annular base portion 30 (see FIG. 4). More specifically, as illustrated in FIG. 4, the intermediate annular space 80 is defined by a sealing surface 82a of the proximal portion 32a of the first flexible sleeve portion 32, a radially extending sealing surface 82b of the proximal portion 32a of the first flexible sleeve portion 32, a sealing surface 84a of the proximal portion 34a of the second flexible sleeve portion 34 and optionally a radially extending abutment surface 30c. While the abutment surface 30c in this example is a part of the annular base portion 30, it may likewise be a surface of the second flexible sleeve portion 34 depending on the configuration of the sealing arrangement 10. It should also be noted that all sealing surfaces and the abutment surface are annular surfaces, extending in the circumferential direction C, as may be gleaned from FIGS. 2a to 2d.

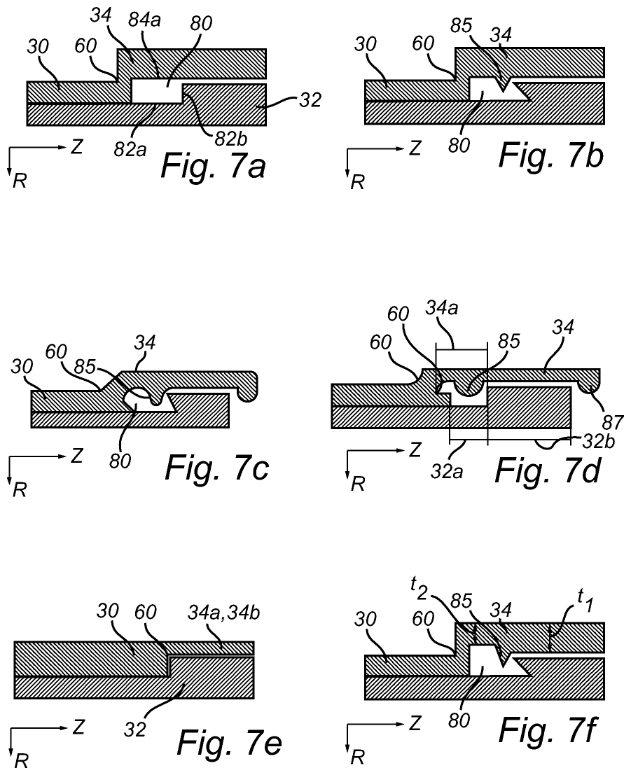

Moreover, in this example, the first flexible sleeve portion 32 further comprises an annular groove 81 (see e.g. FIG. 2a). That is, the proximal portion 32a of the first flexible sleeve portion 32 comprises the annular groove 81. It should be noted that the annular groove 81 may likewise be arranged and/or provided by the proximal portion of the second flexible sleeve portion 34. Accordingly, the intermediate annular space 80 is at least partly defined by an annular groove 81 in any one of the proximal portions of the first and second flexible sleeve portions 32, 34. Further, the annular space 80 may at least partly be defined by the abutment surface of the annular base portion 30, extending in the radial direction R, as illustrated in FIG. 4. As such, the annular base portion 30 here comprises the radially extending abutment surface 30c. The abutment surface 30c is arranged to be in contact with the annular flexible wearable material 11. Hence, the annular flexible wearable material 11 may be positioned so as to abut the abutment surface 30c of the annular base portion 30 when arranged and positioned in the annular space of the sealing arrangement 10. Other examples of the sealing surfaces of the first and second flexible sleeve portions 32, 34 are described herein in relation to FIGS. 4 and FIGS. 7a to 7f.

The sealing-connecting position 42 between the first and second flexible sleeve portions 32, 34 and the annular flexible wearable layer 11 is obtained by means of a friction fit configuration, as illustrated in FIGS. 2d and 4. Hence, the first and second flexible sleeve portions 32, 34 are further configured to form a friction fit over a portion of the insertable annular flexible wearable layer 11, as illustrated in FIGS. 2d and 4. The friction fit is formed by the first and second flexible sleeve portions 32, 34 when the second flexible sleeve portion 34 is in the sealing-connecting position 42. In other words, the friction fit is formed by the first and second flexible sleeve portions 32, 34 when the second flexible sleeve portion 34 is turned into the folded position (FIG. 2d and/or FIG. 4) radially atop the first flexible sleeve portion 32 with the annular flexible wearable layer 11 arranged radially and circumferentially therebetween.

Turning now to FIGS. 5a and 5b, there is provided a number of examples of arrangements of the first and second flexible sleeve portions 32, 34 capable of forming the friction fit. FIG. 5a shows a schematic illustration of a perspective view of the sealing arrangement 10 in FIGS. 2a to 2d and FIG. 4. In FIG. 5a, the friction fit is indicated with the reference numeral 45. The friction fit 45 is provided by the first and second flexible sleeve portions 32, 34 in the sealing-connected position (state) 42 with the annular flexible wearable material 11.

With reference to FIG. 5a, a number of examples of forming the friction fit will now be described in the following. In a first example, denoted as the first friction fit 45a configuration, the friction fit 45 is formed by providing the distal portion 34b of the outer circumferential sleeve, in this example the second flexible sleeve portion 34, with a smaller inner circumference C34 than an outer circumference C32 of the distal portion 32b of the inner circumferential sleeve, in this example the first flexible sleeve portion 32. As such, when the outer circumferential sleeve (second flexible sleeve portion 34) is arranged radially atop the first flexible sleeve portion 32 with the annular flexible wearable layer 11 arranged circumferentially about the first flexible sleeve portion 32 and radially in-between portions of the first and second flexible sleeve portions 32, 34, the friction fit 45a is formed by tension created circumferentially around the annular flexible wearable layer 11 and the distal portion 32b of the inner circumferential sleeve (first flexible sleeve portion 32) due to the circumferential difference between the outer and inner sleeve portions (second and first flexible sleeve portions 34, 32). Thereby, friction is obtained between the sealing surfaces so as to provide a joint and sealing connection therebetween.

To this end, the first and second flexible sleeve portion 32, 34 are designed and manufactured so that the inner circumference C34 of the second flexible sleeve portion 34 is smaller than the outer circumference C32 of the distal portion 32b of the first flexible sleeve portion 32, i.e. C34<C32.

In another example, denoted as the second friction fit 45b configuration, the friction fit 45 is formed by providing the distal portion 34b of the outer circumferential sleeve (here the second flexible sleeve portion 34), with a smaller inner circumference C34 than an outer circumference C11 of the annular flexible wearable layer 11 when it is arranged about the distal portion 32b of the inner circumferential sleeve (the first flexible sleeve portion 32). As such, when the outer circumferential sleeve portion (second flexible sleeve portion 34) is arranged radially atop the first flexible sleeve portion 32 with the annular flexible wearable layer 11 arranged circumferentially around the first flexible sleeve portion 32 and radially in-between the second and first flexible sleeve portions 32, 34, the friction fit 45 is formed by tension created circumferentially around the annular flexible wearable layer 11 and the distal portion 32b of the inner circumferential sleeve (first flexible sleeve portion 32) due to the circumferential difference between the outer second flexible sleeve portion 34 and the circumference of the annular flexible wearable layer 11 when being arranged circumferentially about the inner sleeve portion (first flexible sleeve portion 32).

Accordingly, for the friction fit configuration formed according to the friction fit 45b, the outer circumference C32 of the inner first flexible sleeve portion 32 may necessarily not be bigger than the inner circumference C34 of the distal portion 34b of the outer second flexible sleeve portion 34 as long as the outer circumference C11 of the annular flexible wearable layer 11, when arranged circumferentially atop the inner first flexible sleeve portion 32, is bigger than the inner circumference C34 of the distal portion 34b of the outer second flexible sleeve portion 34.

To this end, the first and second flexible sleeve portion 32, 34, as well as the annular flexible we able layer 11, are designed and manufactured so that the inner circumference C34 of the second flexible sleeve portion 34 is smaller than the outer circumference C11 defined by the annular flexible wearable layer 11 and the outer circumference C32 of the distal portion 32b of the first flexible sleeve portion 32, i.e. C34<C11.

The actual dimensions of the inner circumference C34, the outer circumference C32 and the outer circumference C11 of the annular flexible wearable layer 11 may be selected in several different ways depending on type of sealing arrangement 10 and type of garment 100. However, the dimensions and circumferences should be chosen so that the outer sleeve and inner sleeve portions exert a pressure against the annular flexible wearable layer of at least a magnitude to provide a fluid-tight sealing connection between the sealing surfaces of the sleeve portions 32, 34 and a portion of the inserted annular flexible wearable layer 11.

Hence, the second flexible sleeve portion 34 is manufactured with an inner circumference C34 that is smaller than the outer circumference C32 of the first flexible sleeve portion 32. The actual dimensions are selected so that the second flexible sleeve portion 34 is designed to provide a sufficient pressure (force) on the first flexible sleeve portion 32 in the sealing-connected state 42. The sufficient pressure (force) for obtaining the friction fit can be determined using equations and pre-established values derivable from material specifications of the portions 32, 34 and the annular flexible material layer.

Moreover, the circumferential differences between the inner circumference C34, the outer circumference C32 and the outer circumference C11 of the annular flexible wearable layer 11 are generally determined and measured during manufacturing, i.e. when the portions 32, 34 and 11 are in a relaxed state, or non-tensioned state. In other words, the inner circumference C34, the outer circumference C32 and the outer circumference C11 of the annular flexible wearable layer 11 may generally refer to measures when the portions 32, 34 and 11 are in non-tensioned states.

The dimensions of the first and second flexible sleeve portions 32, 34 in combination with the thickness of the annular flexible wearable layer 11 ensures that there is an adequate tension about the entire circumference of the sealing surfaces of the sealing arrangement 10, thus creating increased friction between a number of mating surfaces defined by the contact surfaces of the sealing surfaces of the sealing arrangement and the contact surfaces of the in-between inserted annular flexible wearable layer 11.

The friction fit 45 is particularly suitable for providing a fluid-tight sealing between the sealing surfaces of the sleeve portions 32, 34 and a portion of the inserted annular flexible wearable layer 11 due to the flexible material characteristics of the components making up the first and second flexible sleeve portions 32, 34 and the annular flexible wearable layer 11. In one example, the sealing arrangement 10 is made of thermoplastic polyurethane (TPU) while the annular flexible wearable layer 11 is made of silicone. In other words, the friction fit is provided by first and second flexible sleeve portions 32, 34 made of thermoplastic polyurethane (TPU) and an annular flexible wearable layer 11 made of silicone. Other examples and combinations of flexible materials are also possible as described herein.

By the configuration of the friction fit as described above in relation to FIG. 5a, the first and second flexible sleeve portions 32, 34 are configured to sealingly connect the inserted annular flexible wearable layer 11 of the other garment portion to the sealing arrangement, thus forming the fluid-tight and connected configuration. That is, the sealing-connecting configuration 42 is formed between mating sealing surfaces of the sealing arrangement 10 and the inserted annular flexible wearable layer 11. More specifically, when the second flexible sleeve portion 34 is circumferentially connected to the first flexible sleeve portion 32 in the friction fit connection 45, the fluid-tight seal configuration 40 is provided over the connection between the first and second flexible sleeve portions 32, 34 with the annular flexible wearable layer 11. That is, the first and second flexible sleeve portions 32, 34 cover the region 40 along the circumferential direction C, as partly illustrated in FIG. 2d.

To sum up, the friction fit 45 is a connection between the first and second flexible sleeve portions 32, 34 and the annular flexible wearable layer 11, which is achieved by friction after the second flexible sleeve portion 34 is arranged, e.g. folded over, the first flexible sleeve portion 32 with the annular flexible wearable layer 11 being arranged in-between the sleeve portions 32, 34. This connection is different to e.g. a hook and look fastening, which relies on a mechanical hook fastening arrangement. The friction fit 45 is achieved by providing the second flexible sleeve portion 34 with an inner circumference C34 being smaller than the outer circumference C32 of the first flexible sleeve portion 32, or smaller than the outer circumference C11 of the annular flexible wearable layer 11 when being arranged on the outer circumference of the first flexible sleeve portion 32. Accordingly, the inner circumference C34 of the second sleeve 34 is made undersized the first sleeve portion 32, or made undersized the annular flexible wearable layer 11 when arranged on the outer circumference C32 of the first sleeve portion 32. As such, there is provided a so called interference fit between the sleeve portions 32, 34 and the annular flexible wearable layer 11 in the sealing-connected position (state) 42.

In the sealing-connected position (state) 42, the undersized second sleeve 34 exerts a pressure against the annular flexible wearable layer 11 and the first sleeve portion 32, entirely around them in the circumferential direction C. Due to the flexible characteristics of the materials of the sleeve portions 32, 34 and the annular flexible wearable layer 11, the result is that the sleeve portion 34 provides a pressure on the first portions 32, creating a sufficient high force on the annular flexible wearable layer 11, and thus a friction fit therebetween. The friction fit between the portions 32, 34 and 11 also provides a sealing effect due to the contact between the portions 32, 34, 11 and due to their flexible and material characteristics. Put it differently, the outer second sleeve portion 34 provides a pressure against the annular flexible wearable layer 11 and the inner first flexible sleeve portion 32 so as to provide the friction fit 45 between the components 32, 34, 11, thereby forming the fluid-tight seal configuration 40 in the sealing-connected configuration 42.

By way of example, the sealing arrangement 10 is obtained by: providing a first flexible sleeve portion 32 having a proximal portion 32a and a distal portion 32b, the distal portion having an outer circumference C32, providing an annular base portion 30 and a second flexible sleeve portion 34, the second flexible sleeve portion extending from the annular base portion 30, and further having a proximal portion 34a and a distal portion 34b in relation to the annular base portion 30, the distal portion 34b having an inner circumference C34, wherein the inner circumference C34 is smaller than the outer circumference C32 of the distal portion 32b of the first flexible sleeve portion 32, and attaching the first flexible sleeve portion 32 to the annular base portion 30, wherein the proximal portions of the first and second flexible sleeve portions extend radially spaced apart from the annular base portion 30,

Alternatively, the sealing arrangement is obtained by providing an annular base portion 30 and a first flexible sleeve portion 32, the first flexible sleeve portion extending from the annular base portion, and further having a proximal portion 32a and a distal portion 32b in relation to the annular base portion, the distal portion having an outer circumference C32, providing a second flexible sleeve portion 34 having a proximal portion 34a and a distal portion 34b, the distal portion 34b having an inner circumference C34, wherein the inner circumference C34 is smaller than the outer circumference C32 of the distal portion of the first flexible sleeve portion, and attaching the second flexible sleeve portion 34 to the annular base portion 30, wherein the proximal portions of the first and second flexible sleeve portions extend radially spaced apart from the annular base portion 30.

The circumferential differences between the second flexible sleeve portion 34 and the combination of the annular flexible wearable layer 11 and the first flexible sleeve portion 32 may also be illustrated by reference to the diameters, as illustrated in FIG. 5b. In a first example, the friction fit 45 is formed by providing the distal portion 34b of the outer circumferential sleeve, in this example corresponding to the second flexible sleeve portion 34, with a smaller inside diameter D1 than an outside diameter d2 of the distal portion 32b of the inner circumferential sleeve, in this example corresponding to the first flexible sleeve portion 32. As such, when the outer circumferential sleeve (second flexible sleeve portion 34) is arranged radially atop the first flexible sleeve portion 32 with the annular flexible wearable layer 11 arranged radially and circumferentially therebetween, the friction fit 45 is formed by tension created circumferentially around the annular flexible wearable layer 11 and the distal portion 32b of the inner circumferential sleeve (first flexible sleeve portion 32) due to the diameter difference between the outer and inner flexible sleeve portions 32, 34. This example of the friction fit configuration is denoted as the first friction fit 45a configuration. In the enlarged views of FIG. 5b, it can be seen that the inside diameter of the second flexible sleeve portion 34 is smaller than the outside diameter d2 of the distal portion 32b of the first flexible sleeve portion 32, i.e. D1<d2.

In another example, denoted as the second friction fit 45b configuration, the friction fit 45 is formed by providing the distal portion 34b of the outer circumferential sleeve (second flexible sleeve portion 34), with a smaller inside diameter D1 than an aggregated outside diameter d1 defined by the radial thickness t of the annular flexible wearable layer 11 and the outside diameter d2 of the distal portion 32b of the inner circumferential sleeve (the first flexible sleeve portion 32). As such, when the outer circumferential sleeve (second flexible sleeve portion 34) is arranged radially atop the first flexible sleeve portion 32 with the annular flexible wearable layer 11 arranged radially and circumferentially therebetween, the friction fit 45 is formed by tension created circumferentially around the annular flexible wearable layer 11 and the distal portion 32b of the inner circumferential sleeve (first flexible sleeve portion 32) due to the diameter difference between the outer sleeve portion 34 and the aggregated diameter dimension of the annular flexible wearable layer 11 and the inner sleeve portion 32. Accordingly, for the friction fit formed according to the friction fit 45b, the outside diameter d2 of the inner sleeve portion 32 may necessarily not be bigger than the inside diameter D1 of the distal portion 34b of the outer circumferential sleeve 34 as long as the aggregated diameter dimension d1 of the annular flexible wearable layer 11 and the inner sleeve portion 32 is bigger than the inside diameter D1 of the distal portion 34b of the outer circumferential sleeve 34. In the enlarged views of FIG. 5b, it can be seen that the inside diameter of the second flexible sleeve portion 34 is smaller than the aggregated outside diameter d1 defined by the annular flexible wearable layer 11 and the outside diameter d2 of the distal portion 32b of the first flexible sleeve portion 32, i.e. D1<d1.

The actual diameters of the inside diameter D1, the outer diameter d2 and the thickness t of the annular flexible wearable layer 11 may be selected in several different ways depending on type of sealing arrangement 10 and type of garment 100. However, the diameters and the thickness should be chosen so that the outer sleeve and inner sleeve portions 32, 34 exert a pressure against the annular flexible wearable layer 11 of at least a magnitude to provide a fluid-tight sealing between the sealing surfaces of the first and second flexible sleeve portions 32, 34 and a portion of the inserted annular flexible wearable layer 11.

The dimensions of the first and second flexible sleeve portions 32, 34, optionally in combination with the thickness t of the annular flexible wearable layer 11 ensure that there is an adequate tension about the entire circumference of the sealing surfaces of the sealing arrangement 10, thus creating increased friction between a number of mating surfaces defined by the contact surfaces of the sealing surfaces of the sealing arrangement 10 and the contact surfaces of the in-between inserted annular flexible wearable layer 11.

The friction fit 45 is particularly suitable for providing a fluid-tight sealing between the sealing surfaces of the first and second flexible sleeve portions 32, 34 and a portion of the inserted annular flexible wearable layer 11 due to the flexible material characteristics of the components making up the first and second flexible sleeve portions 32, 34 and the annular flexible wearable layer 11. In one example, the sealing arrangement 10 is made of thermoplastic polyurethane (TPU) while the annular flexible wearable layer 11 is made of silicone. In other words, the friction fit 45 is provided by first and second flexible sleeve portions 32, 34 made of thermoplastic polyurethane (TPU) and an annular flexible wearable layer 11 made of silicone. Other examples and combinations of flexible materials are also possible as described herein.

By the configuration of the friction fit 45, as described above in relation to FIGS. 5a and 5b, the first and second flexible sleeve portions 32, 34 are configured to sealingly connect the inserted annular flexible wearable layer 11 of the other garment portion to the sealing arrangement 10, thus forming the fluid-tight and connected configuration. That is, the sealing-connecting configuration 42 is formed between mating sealing surfaces of the sealing arrangement 10 and the inserted annular flexible wearable layer 11. More specifically, when the second flexible sleeve portion 34 is circumferentially connected to the first flexible sleeve portion 32 in the friction fit connection 45, the fluid-tight seal configuration 40 is provided over the connection between the first and second flexible sleeve portions 32, 34 with the annular flexible wearable layer 11. That is, the first and second flexible sleeve portions 32, 34 cover the region 40 along the circumferential direction C, as partly illustrated in FIG. 2d.

Now, with respect to FIGS. 2a to 2d, a sequence of connecting and sealing the tubular portions 12 and 14 of the sealing arrangement 10 around the circumferential direction C will be described.

In a disconnected state, represented by FIG. 2a, the annular flexible wearable layer 11 (not shown in FIG. 2a) is completely separated from the sealing arrangement 10. In addition, the first and second flexible sleeve portions 32, 34 are arranged in a superposed configuration. In FIG. 2b, the second flexible sleeve portion 34 is turnable and folded about the imaginary line 60 into the open position 41, which in FIG. 2b is a position in which the second flexible sleeve portion 34 is arranged atop the annular base portion 30. Next, as illustrated in FIG. 2b, the annular flexible wearable layer 11 is axially moved toward the sealing arrangement 10, and subsequently positioned in contact with sealing surfaces of the first flexible sleeve portion 32. In FIG. 2c, the annular flexible wearable layer 11 comprises an outer annular rib portion 13 adapted to be positioned in the intermediate annular space 80 of the sealing arrangement 10. By way of example, the outer annular rib portion 13 and the intermediate annular space 80 of the sealing arrangement 10 are complementary shaped portions. Further, the outer annular rib portion 13 projects away from the surface 72a. Hence, the outer annular rib portion 13 is disposed on the surface 72a.

When the annular flexible wearable layer 11 is fully positioned and arranged circumferentially around the first flexible sleeve portion 32, as illustrated in FIG. 2c, the second flexible sleeve portion 34 is folded back into a position radially atop the first flexible sleeve portion 32 with the annular flexible wearable layer 11 arranged radially therebetween, as illustrated in FIG. 2d. The second flexible sleeve portion is superposed the first flexible sleeve portion and also superposed the annular flexible wearable layer 11. Accordingly, in FIG. 2d, the second flexible sleeve portion 34 is arranged in the sealing-connecting position relative to the first flexible sleeve portion 32 and the annular flexible wearable layer 11.

Due to the dimensional difference between the second flexible sleeve portion 34 and the first flexible sleeve portion 32, as illustrated and described in relation to any one of FIG. 5a and/or FIG. 5b, the first and second flexible sleeve portions 32, 34 provide the friction fit 45 over the inserted annular flexible wearable layer 11.

In this manner, the sealing arrangement 10 is set in its sealing-connected state and the first and flexible sleeve portions 32, 34 are positioned relative each other to form the fluid-tight seal configuration 40. In other words, as described above in relation to FIGS. 2a to 2d and FIGS. 4 and 5, the first and flexible sleeve portions 32, 34 are arranged relative each other and over the annular flexible wearable layer 11 such that a closure of the sealing arrangement 10 along the circumferential direction C brings the portions 32, 34, 11 into the fluid-tight seal configuration 40. The fluid-tight seal configuration 40 extends in a continuous manner along the circumferential direction C of the sealing arrangement 10.

Further, in the sealing connection position 42, as described herein, the first and second flexible sleeve portions 32, 34 are arranged in at least a partly overlapping fluid-tight seal configuration 40 when the second flexible sleeve portion 34 is circumferentially engaged in the friction fit state 45 with the annular flexible wearable layer 11 and the first flexible sleeve portion 32. That is, the first and second flexible sleeve portions 32, 34 overlap each other in the circumferential direction C as well as in the (axial) longitudinal direction Z. In this manner, the first and second flexible sleeve portions 32, 34 are sealingly connected with the annular flexible wearable layer 11 so that fluid, such as water, is prevented from entering to the body part of the user along the sealing surfaces of the first and second flexible sleeve portions 32, 34 and mating surfaces of the annular flexible wearable layer 11.

FIG. 3 schematically illustrates another example embodiment of a sealing arrangement according to the disclosure. In addition to the features described in relation to the sealing arrangement in FIGS. 2a to 2d and FIGS. 4 and 5, the sealing arrangement 10 comprises additional features relating to the second flexible sleeve portion 34 of the arrangement.

As illustrated in FIG. 3, the proximal portion 34a of the second flexible sleeve portion 34 comprises a radial projection 85. The radial projection 85 is arranged to cause an advancement of the inserted annular flexible wearable layer 11 towards the annular base portion 30 when the second flexible sleeve portion 34 is turned from the open position into the sealing-connecting position. The radial projection 85 thus provides an auxiliary radially projecting retaining system. The radial projection 85 is here disposed on the sealing surface 84a of the proximal portion 34a of the second flexible sleeve portion 34. In addition, in FIG. 3, the sealing surface 82a of the proximal portion 32a of the first flexible sleeve portion 32 is here optionally provided as step-shaped sealing surface. However, the sealing surfaces may be provided in other ways, as illustrated in e.g. FIGS. 7a to 7e.

In addition, as illustrated in FIG. 3, the distal portion 34b of the second flexible sleeve portion 34 comprises a radial rib end portion 87. The radial rib end portion 87 is configured to extend axially beyond the distal portion 32b of the first flexible sleeve portion 32 when the second flexible sleeve portion is folded into the sealing-connecting position. In this manner, the friction fit is further improved.

Optionally, as illustrated in FIG. 3, the proximal portion 34a the second flexible sleeve portion 34 comprises an essentially radially transparent region 90 configured to permit a user to visually identify a portion of the inserted annular flexible wearable layer 11 within the annular space 80. In this manner, there is a possibility of determining if the annular flexible wearable layer 11 is correctly positioned and arranged in-between the first and second flexible sleeve portions 32 and 34.

In addition, it should be noted that the annular flexible wearable layer 11 may be designed in several different manners. FIGS. 6a to 6d schematically illustrate a number of examples of annular wearable materials 11 that have been found useful in combination with the sealing arrangement 10 for sealingly connecting with the sealing arrangement to form the fluid-tight seal configuration 40. Accordingly, the annular wearable material 11 may strictly not necessary be shaped as the annular flexible wearable layer 11 in FIGS. 2a to 2d, FIG. 4 and FIG. 5. As illustrated in FIG. 6a, the annular flexible wearable layer 11 comprises an outer annular rib portion 13. The outer annular rib portion 13 has a thickness in the radial direction R that is larger than the thickness of the adjacent portion of the annular flexible wearable layer 11. The outer annular rib portion 13 is adapted to be positioned in the intermediate annular space 80 of the sealing arrangement 10. By way of example, the outer annular rib portion 13 and the intermediate annular space 80 of the sealing arrangement 10 are complementary shape, as illustrated e.g. by the example of the outer annular rib portion 13 in FIG. 6a and the example of the intermediate annular space 80 in FIGS. 2a to 2d, FIG. 4 and FIG. 7a.

In FIG. 6a, the outer annular rib portion 13 projects away from the surface 72a. Hence, the outer annular rib portion 13 is disposed on the surface 72a. In other examples, as illustrated in FIG. 6d, the outer annular rib portion 13a projects away from the surface 70a. Hence, the outer annular rib portion 13a is disposed on the surface 70a. In other examples, the outer annular rib portion 13 projects in both directions, as illustrated in FIG. 6c. Hence, the annular flexible wearable layer 11 comprises radially opposite arranged first and second outer annular rib portions 13a, 13b. The sizes of the first and second outer annular rib portions 13a, 13b may be equal or may differ from each other.

FIGS. 7a to 7d and FIG. 7f illustrates a number of examples of designs of intermediate annular spaces to be used in any one of the example embodiments of the sealing arrangement 10, as described herein. FIG. 7e illustrates an example of a design of the first and second flexible sleeve portions 32, 34 in which there is no substantial intermediate annular space therebetween. Rather, the sealing surfaces of the first and second flexible sleeve portions are essentially flat surfaces, while the inner diameter D1 of the second flexible sleeve portion 34 and the outer diameter d2 are provided as described above in relation to FIGS. 5a and 5b.

Any one of the examples in FIGS. 7a to 7f can be used in the sealing arrangement 10 to form the friction fit, as e.g. described in relation to FIGS. 5a and 5b. By way of example, one of the proximal portions, e.g. the proximal portion 34a of the second flexible sleeve portion 34 is an essentially linear surface and the proximal portion 32a of the first flexible sleeve portion 32 comprises a step-shaped sealing surface 82a, 82b, as illustrated in FIG. 7a (which resembles the annular space in FIGS. 2a to 2d). In addition, or alternatively, the proximal portion 32a of the first flexible sleeve portion 32 may be designed with an inclined radially extending sealing surface 82b, as illustrated in e.g. FIGS. 7b, 7c and 7f. In addition, or alternatively, the proximal portion 34a of the second flexible sleeve portion 34 may comprise the radial projection 85, as also described in relation to the example in FIG. 3. The radial projection 85 extends towards the proximal portion 32a of the first flexible sleeve portion 32. Further, as exemplified by FIGS. 7b to 7d and 7f, the radial projection 85 can be provided in several different shapes and dimensions, including, but not limited to, inclined surfaces, curved surface, hooked surfaces and any combination thereof. In addition, or alternatively, any one of the sealing surfaces of the proximal portions may partly or completely comprise curved sealing surfaces, as illustrated in FIGS. 7c and 7d.

FIG. 7f illustrates one example of an annular space 80 of the second flexible sleeve portion 34 that is particularly useful with the shape of the annular flexible wearable layer 11 in FIG. 6d. The second flexible sleeve portion 34 in FIG. 7f comprises a thickness difference proximal and distal of the radial projection 85. In other words, the intermediate annular space 80 is defined by a sealing surface 82a of the proximal portion 32a of the first flexible sleeve portion 32, a radially extending sealing surface 82b of the proximal portion 32a of the first flexible sleeve portion 32, a sealing surface 84a of the proximal portion 34a of the second flexible sleeve portion 34 and optionally a radially extending abutment surface 30c. In addition, the proximal portion 34a of the second flexible sleeve portion 34 comprises a radial projection 85. The radial projection 85 is arranged to cause an advancement of the inserted annular flexible wearable layer 11 towards the annular base portion 30 when the second flexible sleeve portion 34 is turned from the open position into the sealing-connecting position. The radial projection 85 thus provides an auxiliary radially projecting retaining system. The radial projection 85 is here disposed on the sealing surface 84a of the proximal portion 34a of the second flexible sleeve portion 34. In addition, a radial distance between the sealing surface 84a and the sealing surface 82a proximal to the radial projection 85 is bigger than a radial distance between the sealing surface 84a and the sealing surface 82a distal to the radial projection 85, as illustrated in FIG. 7f. By way of example, such annular space can be obtained by a flexible sleeve portion 34 wherein a radial thickness t2 proximal to the radial projection 85 is less than a radial thickness t1 distal to the radial projection 85, as illustrated in FIG. 7f.

In other examples, although not illustrated, the annular groove is a first annular groove 81 and the other one of the proximal portions of the first and second flexible sleeve portions 32, 34 comprises a corresponding second annular groove (not illustrated). The corresponding second annular groove defines a larger space in the longitudinal (axial) direction Z and in the radial direction R than the first annular groove.

It should be readily appreciated that the second flexible sleeve portion 34 may likewise be arranged along an inner circumferential side facing the user during use of the sealing arrangement 10. Typically, the first and second flexible sleeve portions are attached to the annular base portion. It may also be conceivable that the sealing arrangement is a one-piece module. In other words, the annular base portion, the first flexible sleeve portion and the second flexible sleeve portion are moulded into a single piece sealing arrangement. The one-piece module is made e.g. by additive manufacturing.

It is also possible to fabricate garments with the sealing arrangement 10 being an integral part therein. In such cases, the garment may basically comprise separable tubular portions as described above in relation to any one of the example embodiments of the figures.

The disclosure also relates to a sealing assembly 20 for garments to sealingly connect the sealing arrangement and the annular flexible wearable layer. The sealing assembly comprises the sealing arrangement 10 and the annular flexible wearable layer 11. The annular flexible wearable layer has a radial thickness t defined by an inner annular surface 72a and an outer annular surface 70a thereof. The sealing arrangement 10 comprises the annular base portion and the pair of first and second flexible sleeve portions extending from the annular base portion and configured to form corresponding first and second sealing connector portions, respectively. Each one of the first and second flexible sleeve portions comprises the proximal portion and the distal portion in relation to the annular base portion. Further, the proximal portions extend radially spaced apart from the annular base portion. In addition, one of the first and second flexible sleeve portions is the outer circumferential sleeve and the other one of the first and second flexible sleeve portions is the inner circumferential sleeve. Moreover, at least the inside diameter D1 of the distal portion of the outer circumferential sleeve is smaller than the aggregated outside diameter d1 defined by the radial thickness t of the annular flexible wearable layer and the outside diameter d2 of the distal portion of the inner circumferential sleeve. Also, the second flexible sleeve portion is configured to be turnable about an annular imaginary line and between an open position and a sealing-connecting position, in which at least a portion of the second flexible sleeve portion is superposed the first flexible sleeve portion. In addition, in the sealing-connecting position 42, the proximal portions are configured to collectively define an intermediate annular space 80 for accommodating a portion of the insertable annular flexible wearable layer 11.

The sealing arrangement 10 and/or the sealing assembly 20 can be used in a fluid-protective garment, such as a waterproof garment, a water-resistant garment, a diving suit, a dry suit, a protection suit, a wet suit or a work wear, comprising a first garment portion in the form of the annular flexible wearable layer and a second garment portion in the form of the sealing arrangement as described herein. The sealing arrangement 10 is configured to sealingly connect the annular flexible wearable layer 11.

Hence, thanks to the example embodiment as described above in relation to the FIGS. 1 to 7, it becomes possible to provide reliable and fluid-tight sealing configuration for a garment. In particular, it becomes possible to reduce the number of loose parts making up the sealing arrangement, thus providing a more user friendly and intuitive sealing system for sealingly connecting tubular portions of one or more garments making up a dry suit or the like. It should also be noted that the sealing arrangement as described in the example embodiments above may be specifically suited for an easy removal of one of the tubular portions from the other one of the tubular portions by means of turning the second flexible sleeve portion to the open position.

In other words, the disclosure is capable of modification in various obvious respects, all without departing from the scope of the appended claims. Accordingly, the drawings and the description are to be regarded as illustrative in nature, and not restrictive. Thus, reference signs mentioned in the claims should not be seen as limiting the extent of the matter protected by the claims, and their sole function is to make claims easier to understand.

Features illustrated in the different example sealing arrangements and example embodiments described above may be combined as understood by a person skilled in the art. Although the disclosure has been described with reference to example garments and sealing arrangement, many different alterations, modifications, and the like will become apparent for those skilled in the art. For example, the sealing arrangement can be arranged at other annular garments sections. Further, the sealing arrangement may be used for other purposes than those explicitly mentioned here.

As used herein, the term “comprising” or “comprises” is open-ended, and includes one or more stated features, elements, steps, components or functions but does not preclude the presence or addition of one or more other features, elements, steps, components, functions or groups thereof. Similarly, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

1. A sealing arrangement for garments to sealingly connect with an annular flexible wearable layer, said sealing arrangement having an annular base portion and a pair of first and second flexible sleeve portions extending from the annular base portion and configured to form corresponding first and second sealing connector portions, respectively, each one of the first and second flexible sleeve portions having a proximal portion and a distal portion in relation to the annular base portion, said proximal portions extending radially spaced apart from the annular base portion,
wherein the second flexible sleeve portion is configured to be turnable about an annular imaginary line and between an open position and a sealing-connecting position relative to the first flexible sleeve portion, in which at least a portion of the second flexible sleeve portion is superposed the first flexible sleeve portion, and
wherein the first and second flexible sleeve portions are further configured to form a friction fit over a portion of the annular flexible wearable layer in said sealing-connecting position.

2. A sealing arrangement for garments to sealingly connect with an annular flexible wearable layer, said sealing arrangement having an annular base portion and a pair of first and second flexible sleeve portions extending from the annular base portion and configured to form corresponding first and second sealing connector portions, respectively, each one of the first and second flexible sleeve portions having a proximal portion and a distal portion in relation to the annular base portion, said proximal portions extending radially spaced apart from the annular base portion,
wherein one of the first and second flexible sleeve portions is an outer circumferential sleeve and the other one of the first and second flexible sleeve portions is an inner circumferential sleeve, and wherein at least an inner circumference of the distal portion of the outer circumferential sleeve is smaller than an outer circumference of the distal portion of the inner circumferential sleeve, and
wherein the second flexible sleeve portion is configured to be turnable about an annular imaginary line between an open position and a sealing-connecting position relative to the first flexible sleeve portion, in which at least a portion of the second flexible sleeve portion is superposed the first flexible sleeve portion.

3. The sealing arrangement according to claim 1, wherein, in said sealing-connecting position, the proximal portions are configured to collectively define an intermediate annular space for accommodating a portion of the annular flexible wearable layer.

4. The sealing arrangement according to claim 3, wherein the intermediate annular space is at least partly defined by an annular groove in any one of the proximal portions of the first and second flexible sleeve portions.

5. The sealing arrangement according to claim 1, wherein the other one of the proximal portions of the first and second flexible sleeve portions comprises an essentially linear surface.

6. The sealing arrangement according to claim 4, wherein the annular groove is a first annular groove and the other one of the proximal portions of the first and second flexible sleeve portions comprises a corresponding second annular groove, said corresponding second annular groove defines a larger space in an axial direction and in a radial direction than the first annular groove.

7. The sealing arrangement according to claim 1, wherein the proximal portion of the second flexible sleeve portion comprises a radial projection arranged to cause an advancement of the insertable annular flexible wearable layer towards the annular base portion when the second flexible sleeve portion is turned from the open position into the sealing-connecting position.

8. The sealing arrangement according to claim 1, wherein the distal portion of the second flexible sleeve portion comprises a radial rib end portion configured to extend axially beyond the distal portion of the first flexible sleeve portion when the second flexible sleeve portion is turned into the sealing-connecting position.

9. The sealing arrangement according to claim 1, wherein the second flexible sleeve portion is arranged along an outer circumferential side of the annular base portion facing away from the body portion of the user during use of the sealing arrangement.

10. The sealing arrangement according to claim 1, wherein the second flexible sleeve portion is arranged along an inner circumferential side facing the user during use of the sealing arrangement.

11. The sealing arrangement according to claim 1, wherein any one of the first and second flexible sleeve portions is attached to the annular base portion.

12. The sealing arrangement according to claim 1, wherein the proximal portion of any one of one of the first and second flexible sleeve portions comprises an essentially radially transparent region configured to permit a user to visually identify a portion of the annular flexible wearable layer within the annular space.

13. The sealing arrangement according to claim 1, wherein the second flexible sleeve portion is configured to be foldable between the open position, in which the second flexible sleeve portion is arranged radially atop a portion of the annular base portion, and the sealing-connecting position, in which the second flexible sleeve portion is arranged radially atop a portion of the first flexible sleeve portion.

14. The sealing arrangement according to claim 1, wherein each one of the annular base portion, first flexible sleeve portion and second flexible sleeve portion is made of a flexible material.

15. The sealing arrangement according to claim 1, wherein the first flexible sleeve portion comprises a sealing surface and the second flexible sleeve portion comprises a corresponding sealing surface, whereby at least any one of a portion of the sealing surface of the first flexible sleeve portion and a portion of the sealing surface of the second flexible sleeve portion is arranged in contact with the annular flexible wearable layer, when the second flexible sleeve portion is in the sealing-connecting position, so as to form a fluid-tight seal configuration therebetween.

16. The sealing arrangement according to claim 1, wherein the annular base portion and the second flexible sleeve portion are a one-piece module and the first flexible sleeve portion is a separate part attached to the annular base portion.

17. The sealing arrangement according to claim 1, wherein the sealing arrangement is a one-piece module.

18. The sealing arrangement according to claim 1, wherein the one-piece module is made by additive manufacturing.

19. The sealing arrangement according to claim 2, wherein, in the sealing-connecting position, the difference between the inner circumference of the distal portion of the outer circumferential sleeve and the outer circumference of the distal portion of the inner circumferential sleeve provides a friction fit over a portion of the annular flexible wearable layer.

20. A sealing arrangement for garments to sealingly connect with an annular flexible wearable layer, the sealing arrangement being obtainable by:
providing a first flexible sleeve portion having a proximal portion and a distal portion, the distal portion having an outer circumference,
providing an annular base portion and a second flexible sleeve portion, said second flexible sleeve portion extending from the annular base portion, and further having a proximal portion and a distal portion in relation to the annular base portion, the distal portion having an inner circumference, wherein said inner circumference is smaller than the outer circumference of the distal portion of the first flexible sleeve portion, and
attaching said first flexible sleeve portion to the annular base portion, wherein the proximal portions of the first and second flexible sleeve portions extend radially spaced apart from the annular base portion,
or, obtainable by
providing an annular base portion and a first flexible sleeve portion, said first flexible sleeve portion extending from the annular base portion, and further having a proximal portion and a distal portion in relation to the annular base portion, the distal portion having an outer circumference,
providing a second flexible sleeve portion having a proximal portion and a distal portion, the distal portion having an inner circumference, wherein said inner circumference is smaller than the outer circumference of the distal portion of the first flexible sleeve portion, and
attaching said second flexible sleeve portion to the annular base portion, wherein the proximal portions of the first and second flexible sleeve portions extend radially spaced apart from the annular base portion.

21. A sealing assembly for garments to sealingly connect a sealing arrangement and an annular flexible wearable layer, said sealing assembly comprising the sealing arrangement and the annular flexible wearable layer, said annular flexible wearable layer having a radial thickness defined by an inner annular surface and an outer annular surface thereof, said sealing arrangement having an annular base portion and a pair of first and second flexible sleeve portions extending from the annular base portion and configured to form corresponding first and second sealing connector portions, respectively, each one of the first and second flexible sleeve portions having a proximal portion and a distal portion in relation to the annular base portion, said proximal portions extending radially spaced apart from the annular base portion,
wherein one of the first and second flexible sleeve portions is an outer circumferential sleeve and the other one of the first and second flexible sleeve portions is an inner circumferential sleeve, and wherein at least an inner circumference of the distal portion of the outer circumferential sleeve is smaller than an outer circumference of the annular flexible wearable layer as measured when the annular flexible wearable layer being arranged about the distal portion of the inner circumferential sleeve,
wherein the second flexible sleeve portion is configured to be turnable about an annular imaginary line and between an open position and a sealing-connecting position relative to the first flexible sleeve portion, in which at least a portion of the second flexible sleeve portion is superposed the first flexible sleeve portion.

22. The sealing assembly according to claim 21, wherein, in the sealing-connecting position, the difference between the inner circumference of the distal portion of the outer circumferential sleeve and the outer circumference of the distal portion of the inner circumferential sleeve provides a friction fit over a portion of the annular flexible wearable layer.

23. A fluid-protective garment, such as a waterproof garment, a water-resistant garment, a diving suit, a dry suit, a protection suit, a wet suit or a work wear, comprising a first garment portion in the form of an annular flexible wearable layer and a second garment portion in the form of a sealing arrangement according to claim 1, wherein the sealing arrangement is configured to sealingly connect with the annular flexible wearable layer.
